(19) United States
(12) Patent Application Publication
(10) Pub. No.: US 2017/0134138 A1
(43) Pub. Date: May 11, 2017

(54) WIRELESS COMMUNICATION DEVICE AND WIRELESS COMMUNICATION METHOD

(71) Applicant: KABUSHIKI KAISHA TOSHIBA, Tokyo (JP)

(72) Inventors: Narendar Madhavan, Kawasaki (JP); Toshihisa Nabetani, Kawasaki (JP); Haruka Obata, Tokyo (JP); Tsuguhide Aoki, Kawasaki (JP)

(73) Assignee: KABUSHIKI KAISHA TOSHIBA, Tokyo (JP)

(21) Appl. No.: 15/266,613

(22) Filed: Sep. 15, 2016

(30) Foreign Application Priority Data
Nov. 9, 2015 (JP) 2015-219774
Sep. 13, 2016 (JP) 2016-178901

(51) Int. Cl. H04L 5/00; H04W 72/00

(52) U.S. Cl. CPC H04L 5/0055; H04W 72/005; H04B 7/0452

(57) ABSTRACT

According to one embodiment, a wireless communication device includes a transmitter configured to transmit a plurality of first frames by multiplexing, the plurality of first frames each belonging to any one of a plurality of groups; and a receiver configured to receive, at timing not temporally overlapping among the groups, a plurality of second frames which are multiplexed, the plurality of second frames each indicating acknowledgement on the first frame belonging to each group.

### CROSS-REFERENCE TO RELATED APPLICATIONS

This application is based upon and claims the benefit of priority from Japanese Patent Application No. 2015-219774, filed on Nov. 9, 2015 and No. 2016-178901, filed on Sep. 13, 2016; the entire contents of which are incorporated herein by reference.

### FIELD

Embodiments described herein are related to a wireless communication device and a wireless communication method.

### BACKGROUND

A wireless communication system is known in which an access point communicates with wireless communication terminals (hereinafter, “terminals”). For example, a widely-known wireless Local Area Network (LAN) uses Carrier Sense Multiple Access/Collision Avoidance (CSMA/CA). According to a method known to be used in such a wireless LAN, an access point transmits a plurality of data frames to a plurality of terminals, by using a Multi-User Multi-Input Multi-Output (MU-MIMO) scheme. As a method in which the plurality of terminals that have received the data frames by the MU-MIMO scheme each transmit an acknowledgement response frame (a Block ACK or the like) through a primary channel, a method is known by which information indicating the order in which the acknowledgement response frames are to be transmitted from the plurality of terminals is transmitted together with the data frames. This method prevents the acknowledgement response frames sent by the plurality of terminals from colliding with one another. However, a problem arises where, when the acknowledgement response frames are sequentially returned from the terminals, it takes a long period of time before the transmissions of the acknowledgement response frames of all the terminals are completed.

Let us discuss an example of a next-generation wireless LAN system such as one compliant with IEEE 802.11ax where an access point transmits a plurality of data frames to a plurality of terminals by using a DownLink Multi-User (DL-MU) mode, whereas the plurality of terminals that have received the data frames simultaneously transmit acknowledgement response frames by using an UpLink Multi-User (UL-MU) mode. In that situation, the number of users for which the data frames are multiplexed in the downlink transmission from the access point may be larger than the number of users for which acknowledgement response frames are multiplexable in the UL-MU mode. In an example, when the access point transmits the data frames to the plurality of terminals by using a combined scheme of Orthogonal Frequency Division Multiple Access (OFDMA) and MU-MIMO, whereas the plurality of terminals transmit the acknowledgement response frames to the access point by using only one of either MU-MIMO or OFDMA, the maximum possible multiplexing number in the downlink is larger than the maximum possible multiplexing number in the uplink. In that situation, there is a possibility that not all the terminals may be able to return the acknowledgement response frames simultaneously.

### BRIEF DESCRIPTION OF THE DRAWINGS

FIG. 1 is a drawing illustrating a wireless communication system according to a first embodiment;

FIG. 2 is a drawing explaining an allocation of resource units;

FIG. 3 is a drawing explaining modes of the resource units;

FIG. 4 is a drawing explaining a concept of MU-MIMO;

FIG. 5 is a drawing illustrating examples of packet formats used in a UL-MU-MIMO transmission;

FIG. 6 is a drawing explaining a concept of DL-MU-MIMO;

FIG. 7 is a drawing explaining a concept of UL-OFDMA & MU-MIMO;

FIG. 8 is a drawing explaining a concept of DL-OFDMA & MU-MIMO;

FIG. 9 is a drawing illustrating an example of a basic format of a MAC frame;

FIG. 10 is a drawing illustrating an example of a format of information element;

FIG. 11 is a drawing illustrating an example of a first operation sequence according to the first embodiment;

FIG. 12 is a drawing illustrating an example of a format of a trigger frame;

FIG. 13 is a drawing illustrating an example of a format of a physical packet containing a trigger frame;

FIG. 14 is a drawing illustrating another example of the format of a trigger frame;

FIG. 15 is a drawing illustrating an example of a packet format used in DL-OFDMA;

FIG. 16 is a drawing illustrating an example of a second operation sequence according to the first embodiment;

FIG. 17 is a drawing illustrating an example of a third operation sequence according to the first embodiment;

FIG. 18 is a drawing illustrating yet another example of the format of a trigger frame;

FIG. 19 is a drawing illustrating an example of a fourth operation sequence according to the first embodiment;

FIG. 20 is a drawing illustrating an example of a fifth operation sequence according to the first embodiment;

FIG. 21 is a functional block diagram of a wireless communication device installed in an access point according to the first embodiment;

FIG. 22 is a functional block diagram of a wireless communication device installed in one of terminals according to the first embodiment;

FIG. 23 is a drawing illustrating a flowchart of an operation performed by the access point according to the first embodiment;

FIG. 24 is a drawing illustrating a flowchart of an operation performed by one of the terminals according to the first embodiment;

FIG. 25 is a functional block diagram of a base station or a terminal in accordance with a second embodiment;

FIG. 26 is a diagram illustrating an example of an overall configuration of one of the terminals or an access point according to a second embodiment;

FIG. 27 is a diagram illustrating an example of a hardware configuration of a wireless communication device installed in one of the terminals or the access point according to a third embodiment;

FIG. 28 is a perspective view of one of the terminals according to a fourth embodiment;

FIG. 29 is a drawing of a memory card according to the fourth embodiment; and

FIG. 30 is a drawing illustrating an example of a frame exchange process during a contention period.

### DETAILED DESCRIPTION

According to one embodiment, a wireless communication device includes a transmitter configured to transmit a plurality of first frames by multiplexing, the plurality of first frames each belonging to any one of a plurality of groups; and a receiver configured to receive, at timing not temporally overlapping among the groups, a plurality of second frames which are multiplexed, the plurality of second frames each indicating acknowledgement on the first frame belonging to each group.

Hereinafter, embodiments of the present invention will be described with reference to the drawings. The entire contents of IEEE Std 802.11™-2012 and IEEE Std 802.11ac™-2013, known as the wireless LAN specification and IEEE 802.11-15/0132r9 dated Sep. 22, 2015 which is Specification Framework Document directed to IEEE Std 802.11ax as a next generation wireless LAN standards are herein incorporated by reference in the present specification.

### First Embodiment

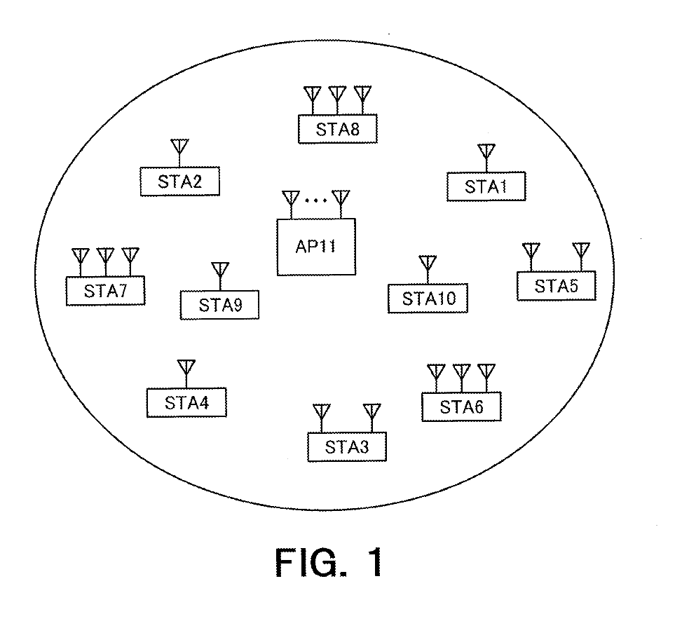

FIG. 1 is a drawing illustrating a wireless communication system according to a first embodiment.

The wireless communication system illustrated in FIG. 1 includes an access point (AP) 11 serving as a base station and a plurality of wireless communication terminals (which hereinafter may be referred to as “terminals”) 1, 2, 3, 4, 5, 6, 7, 8, 9, and 10. The terminals are called “STA” in the drawing. The wireless communication network in the present example is a wireless Local Area Network (LAN) implementing Carrier Sense Multiple Access/Collision Avoidance (CSMA/CA). Basically, the access point 11 also has the same functions as those of each of the terminals 1 to 10 and is considered as one mode of the terminal, except that the access point 11 has a relay function and the like. It is assumed that the access point 11 and the terminals 1 to 10 perform a wireless communication compliant with the IEEE 802.11 standard; however, the access point 11 and the terminals 1 to 10 may perform a communication compliant with any other wireless communication scheme. In the following explanations, the term “terminal” may refer to the access point also, unless it is clear from the context that the “terminal” cannot be the access point.

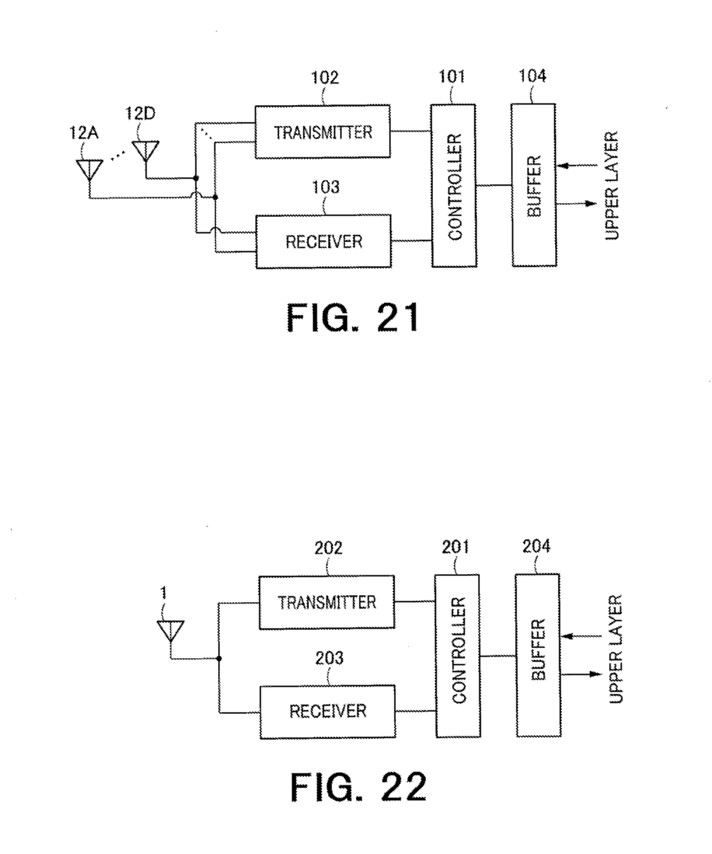

The access point 11 includes at least one antenna. In the present example, the access point 11 includes a plurality of antennas. The access point 11 has installed therein a wireless communication device (see FIG. 21 explained later) configured to control communication by transmitting and receiving MAC frames (which hereinafter may be referred to as “frames”) to and from a plurality of terminals by using these antennas. The wireless communication device includes a wireless communicator that is connected to the antennas and is configured to transmit and receive the frames and a controller configured to control the communication with the terminals 1 to 10. In an example, the wireless communicator is configured by using a Radio Frequency (RF) integrated circuit. In an example, the controller is configured by using controlling circuitry or a baseband integrated circuit. However, possible embodiments are not limited to these examples.

Each of the terminals 1 to 10 includes one or more antennas. Each of the terminals has installed therein a wireless communication device (see FIG. 22 explained later) configured to control communication by transmitting and receiving frames to and from the access point 11 by using the antenna. The wireless communication device installed in each of the terminals 1 to 10 includes a wireless communicator that is connected to the antenna and is configured to transmit and receive the frames and a controller configured to control the communication with the access point 11. In an example, the wireless communicator is configured by using a Radio Frequency (RF) integrated circuit. In an example, the controller is configured by using controlling circuitry or a baseband integrated circuit. However, possible embodiments are not limited to these examples.

The access point 11 forms a wireless network (hereinafter, a “first network”) with the terminals 1 to 10. Further, separately from the first network, the access point 11 may be connected to another network (hereinafter, a “second network”) that is one selected from among a wired network, a wireless network, and a wired/wireless hybrid network. The access point 11 may also be configured to relay a communication between the first network and the second network. Further, the access point 11 may also be configured to relay a communication among the plurality of terminals in the first network. A frame generated by any of the terminals 1 to 10 is transmitted to the access point 11. The access point 11 may transmit the frame to another one of the terminals in the first network or to the second network, in accordance with the destination address thereof. The frame mentioned in the present description may be what is called a frame or may be what is called a packet, according the IEEE 802.11 standard, for example.

In the present example, the access point 11 is capable of performing a multiplexing communication, which is more specifically, a Multi-User (MU) communication, with a plurality of terminals selected from among the terminals 1 to 10. Examples of schemes used for the MU communication include Multi-User Multi-Input Multi-Output (MU-MIMO) and Orthogonal Frequency Division Multiple Access (OFDMA). In addition, there is another scheme (MU-MIMO & OFDMA) being a combined scheme of MU-MIMO and OFDMA.

An MU-MIMO communication in an uplink (UpLink) will be expressed as UL-MU-MIMO, whereas an MU-MIMO communication in a downlink (DownLink) will be expressed as DL-MU-MIMO. Further, an OFDMA communication in an uplink will be expressed as UL-OFDMA, whereas an OFDMA communication in a downlink will be expressed as DL-OFDMA. Further, an MU-MIMO & OFDMA communication in an uplink will be expressed as UL-MU-MIMO & OFDMA, whereas an MU-MIMO & OFDMA communication in a downlink will be expressed as DL-MU-MIMO & OFDMA.

In the present embodiment, it is assumed that at least one selected from among DL-MU-MIMO, DL-OFDMA, and DL-MU-MIMO & OFDMA is executable as a downlink communication between the access point 11 and the plurality of terminals. Also, it is assumed that at least one selected from among UL-MU-MIMO, UL-OFDMA, and UL-MU-MIMO & OFDMA is executable as an uplink communication between the access point 11 and the terminals.

Next, outlines of OFDMA, MU-MIMO, and MU-MIMO & OFDMA will be explained.

OFDMA is a communication scheme by which either transmissions to the plurality of terminals or receptions from the plurality of terminals are simultaneously performed, by using a plurality of resource units each including one or more sub-carriers as the smallest unit of a communication resource (a frequency component). The simultaneous transmission from the access point to the plurality of terminals corresponds to DL-OFDMA, whereas the simultaneous transmission from the plurality of terminals to the access point corresponds to UL-OFDMA. The resource unit may be referred to as a sub-channel, a resource block, or a frequency block.

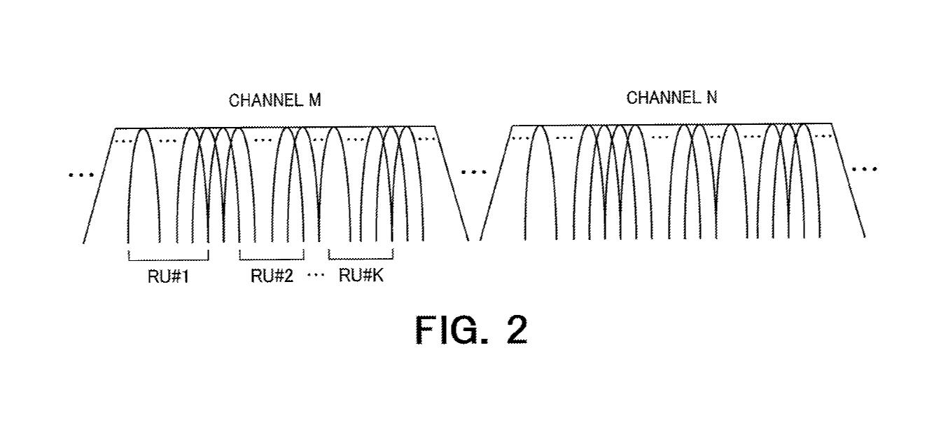

FIG. 2 illustrates the resource units (RU#1, RU#2 . . . RU#K) arranged within a continuous frequency domain of one channel (which is described here as the channel M). A plurality of subcarriers orthogonal to each other are arranged in the channel M, and a plurality of resource units including one or a plurality of continuous subcarriers are defined within the channel M. Although one or more subcarriers (guard subcarriers) may be arranged between the resource units, presence of the guard subcarrier is not essential. A number for identification of the subcarrier or the resource unit may be assigned to each carrier or each resource unit in the channel. The bandwidth of one channel may be for example, though not limited to these, 20 MHz, 40 MHz, 80 MHz, and 160 MHz. One channel may be constituted by combining a plurality of channels of 20 MHz. The number of subcarriers in the channel or the number of resource units may vary in accordance with the bandwidth. Uplink OFDMA communication is realized by different resource units being simultaneously used by different terminals.

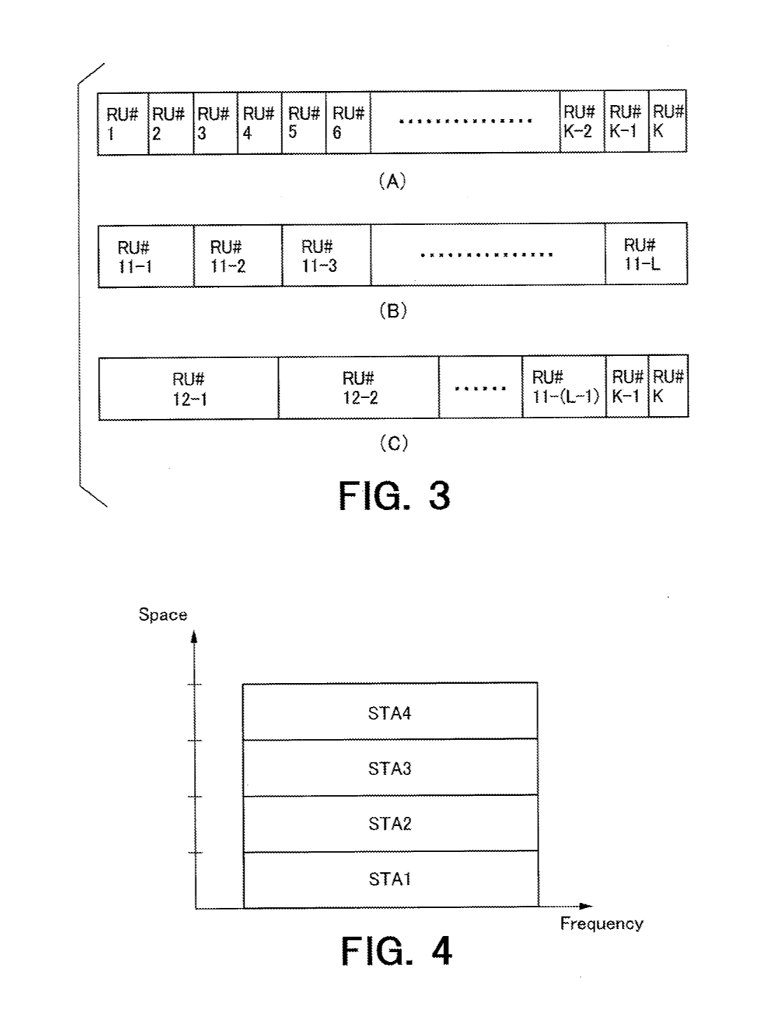

The bandwidths of the resource units (or the number of the subcarriers) may be same among the resource units, or the bandwidths (or the number of the subcarriers) may vary depending on the individual resource units. An exemplary arrangement pattern of the resource units within one channel is schematically illustrated in FIG. 3. The width direction on the paper surface corresponds to the frequency domain direction. FIG. 3(A) illustrates an example where a plurality of resource units (RU#1, RU#2 . . . RU#K) having the same bandwidth are arranged, and FIG. 3(B) illustrates another example where a plurality of resource units (RU#11-1, RU#11-2 . . . RU#11-L) having a larger bandwidth than that of FIG. 3(A) are arranged. FIG. 3(C) illustrates a still another example where resource units with three types of bandwidths are arranged. The resource units (RU#12-1, RU#12-2) have the largest bandwidth, the resource unit RU#11-(L-1) has the bandwidth identical to that of FIG. 3(B), and the resource units (RU#K-1, RU#K) have the bandwidth identical to that of FIG. 3(A).

A specific example is illustrated. When the entire 20 MHz channel width is used, 26 tones of the total 256 subcarriers (tones) may be allocated for a single RU within the 20 MHz channel width. In other words, nine resource units are specified in the 20 MHz channel width and the bandwidth of the resource unit becomes smaller than the 2.5 MHz width. In the case of a 40 MHz channel width, 18 resource units are specified. In the case of an 80 MHz channel width, 37 resource units are specified. When this is extended, for example, in the case of a 160 MHz channel width or an 80+80 MHz channel width, 74 resource units are specified. It should be noted that the width of the resource unit is not limited to a particular value and resource units of various sizes can be arranged.

Here, the number of resource units used by each terminal is not limited to a particular value and one or a plurality of resource units may be used. When a terminal uses a plurality of resource units, a plurality of resource units that are continuous in terms of frequency may be used, or a plurality of resource units that are located at positions away from each other may be allowed to be used. The resource unit #11-1 may be regarded as one example of a resource unit bonding the resource units #1 and #2.

It is assumed here that subcarriers within one resource unit are continuous in the frequency domain. However, resource units may be defined with use of a plurality of subcarriers that are arranged in a non-continuous manner. The channels used in uplink OFDMA communication are not limited to one single channel but resource units may be reserved in another channel (see the channel N in FIG. 2, for example) arranged at a location away in the frequency domain from the channel M as the case of the channel M and thus the resource units in both the channel M and the channel N may be used. The same or different modes of arranging the resource units may be used for the channel M and the channel N. The bandwidth of the channel N is by way of example 20 MHz, 40 MHz, 80 MHz, 160 MHz, etc. as described above but not limited to them. It is also possible to use three or more channels. It is considered here that the combining of the channel M and the channel N may be regarded as one single channel.

It is assumed here that a terminal that implements OFDMA is capable of carrying out reception and decoding (including demodulation, decoding of error-correcting code, etc.) of a physical packet including a frame on a channel of at least the basic channel width of a legacy terminal (20 MHz channel width if an IEEE 802.11a/b/g/n/ac standard-compliant terminal is regarded as a legacy terminal), meaning; backward-compatible. Carrier sense is carried out in a unit of the basic channel width.

The carrier sense may encompass both physical carrier sense associated with busy/idle of CCA (Clear Channel Assessment) and Virtual Carrier Sense based on medium reserve time described in the received frame. As in the case of the latter, a scheme for virtually determining that a medium is in the busy state, or the term during which the medium is virtually regarded as being in the busy state is called Network Allocation Vector (NAV). Here, carrier sense information based on CCA or NAV carried out in a unit of a channel may be universally applied to all the resource units within the channel. For example, resource units belonging to the channel indicated as idle by the carrier sense information are all in the idle state.

With regard to OFDMA, channel-based OFDMA is also possible in addition to the above-described resource-unit-based OFDMA. OFDMA of this case may in particular be called MU-MC (Multi-User Multi-Channel). In MU-MC, a base station assigns a plurality of channels (one channel width is, for example, 20 MHz, etc.) to a plurality of terminals, and the plurality of channels are simultaneously used to carry out simultaneous transmissions to the plurality of terminals or simultaneous receptions from the plurality of terminals. The OFDMA which will be described below means the resource-unit-based OFDMA: however, an embodiment of channel-based OFDMA can also be implemented with appropriate replacement of terms and phrases in the following explanations such as reading the “resource unit” as the “channel”.

UL-MU-MIMO is a scheme intended to make uplink transmissions more efficient, by arranging the plurality of terminals to each transmit (by a spatially multiplexing transmission) a frame to the access point by using mutually-the-same timing and mutually-the-same frequency band. FIG. 4 is a drawing for explaining a concept of MU-MIMO. Let us discuss an example in which the access point 11 performs a UL-MU-MIMO communication with four terminals, namely the terminals 1 to 4. The terminals 1 to 4 simultaneously transmit frames by using mutually-the-same channel (of which the bandwidth may be arbitrary, such as 20 MHz, 40 MHz, or 80 MHz). The access point receives these frames at the same time, but is capable of separating these frames by using a preamble signal contained in a physical header of each of the frames. Details of this capability will be explained in detail below.

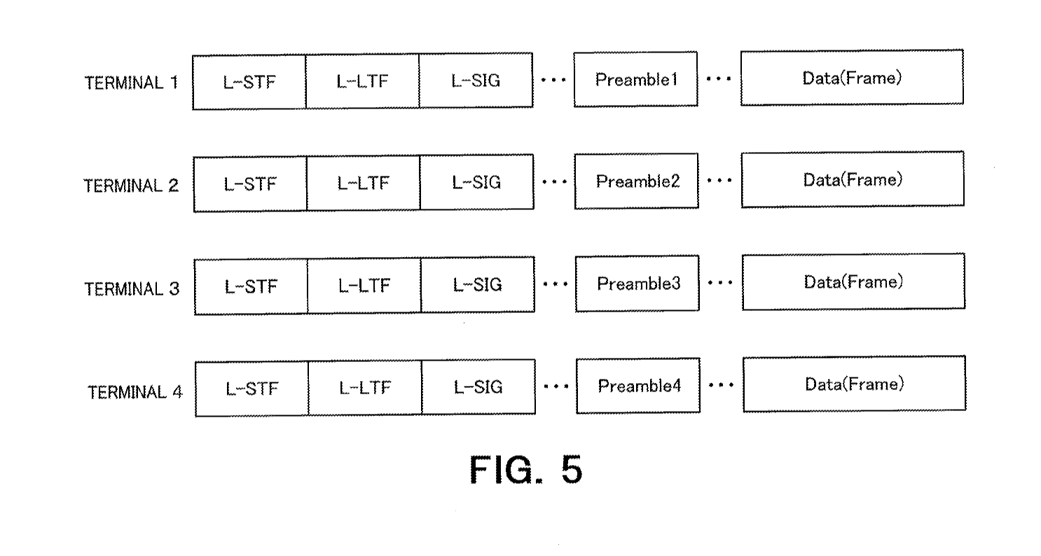

The access point 11 receives the frames transmitted from the terminals by UL-MU-MIMO, as simultaneously-multiplexed signals. When implementing the UL-MU-MIMO scheme, the access point needs to spatially separate the frames of the plurality of terminals from the signals that were simultaneously received from the terminals. For this purpose, the access point 11 utilizes a channel response of the uplink with each of the plurality of terminals. The access point is capable of estimating the channel responses of the uplinks with the terminals by using the preamble signal added on the head side of the frame transmitted by each of the terminals. More specifically, each of the preamble signals is contained in a preamble signal field within the physical header positioned on the head side of the frame. FIG. 5 illustrates examples of configurations of physical packets containing the frames transmitted by the terminals 1 to 4. As illustrated in FIG. 5, each of the preamble signals is disposed in the preamble signal field positioned between an L-SIG field and a frame. Preamble signals 1 to 4 of the terminals 1 to 4 are orthogonal to one another. The fields disposed to the front of each of the preamble signals 1 to 4, such as a Legacy-Short Training Field (L-STF), a Legacy-Long Training Field (L-LTF), and a Legacy Signal Field (L-SIG) are fields that are recognizable by a terminal compliant with a legacy standard such as one in IEEE 802.11a, for example, and have stored therein information related to signal detection, frequency correction (channel estimation), and a transmission rate. The L-STF, the L-LTF, and the L-SIG are the same signals among the plurality of terminals performing the UL-MU-MIMO transmission. The preamble signals described above correspond to an example of a communication resource according to the present embodiment. Next, the preamble signals will be explained.

Each of the preamble signals is configured with either a known bit string or a known symbol string. By estimating the channel responses of the uplinks by using the known bit string, the access point 11 is able to spatially separate (decode) the fields properly that are positioned to the rear of the preamble signals. It is possible to realize the spatial separation by using any of the well-known arbitrary methods such as Zero-Forcing (ZF) method, Minimum Mean Square Error (MMSE) method, and maximum likelihood estimation method, for example. In an example, each of the preamble signals is disposed in the physical header (PHY header) positioned on the head side of the MAC frame. In any of the fields positioned to the front of the preamble signals within the physical headers, because signals that are mutually the same are transmitted from the terminals, the access point is able to decode these signals even when the signals are received simultaneously. Further, the preamble signals from the terminals are orthogonal to one another. For this reason, the access point 11 is able to individually recognize each of the preamble signals simultaneously received from the terminals. Accordingly, the access point 11 is able to estimate the uplink channels from the terminals to the access point 11 by using the preamble signals each corresponding to a different one of the terminals. Even though the signals that are mutually different among the terminals are transmitted in the portions positioned to the rear of the preamble signals, the access point 11 is able to separate these signals by utilizing the estimated channel responses.

As a method for arranging the preamble signals among the terminals to be orthogonal to one another, it is possible to use any of the following methods: a time method, a frequency method, and a code method. When a time orthogonalization method is used, the preamble signal field is divided into a plurality of sections, so that the preamble signals from the terminals are transmitted in mutually-different sections. It means that in any one of the sections, only one terminal is transmitting a preamble signal. In other words, while one of the terminals is transmitting a preamble signal, the other terminals are in the time period of transmitting nothing. When the frequency orthogonalization method is used, the terminals transmit preamble signals at frequencies that are in an orthogonal relationship with one another. When the code orthogonalization method is used, the terminals transmit signals having disposed therein value sequences (or, more specifically, symbol sequences corresponding to the value sequences) contained in mutually-different rows (or mutually-different columns) of an orthogonal matrix. The rows (or the columns) of the orthogonal matrix are in an orthogonal relationship with one another. By using any of these orthogonalization methods, the access point 11 is able to recognize the preamble signals of the terminals.

In order for the terminals to use the preamble signals that are orthogonal to one another, the access point needs to provide the terminals with information about the preamble signals to be used by the terminals and the transmission methods therefore. More specifically, it is necessary to provide information such as the timing with which the terminals each transmit the preamble signal (where the preamble signals may be mutually the same or mutually different among the terminals) when the time orthogonalization method is used; the frequency at which the terminals each transmit the preamble signal (where the preamble signals may be mutually different or mutually the same among the terminals) when the frequency orthogonalization method is used; or what code pattern (a pattern of which row/column in the orthogonal matrix) is to be used for transmitting the preamble signals when the code orthogonalization method is used.

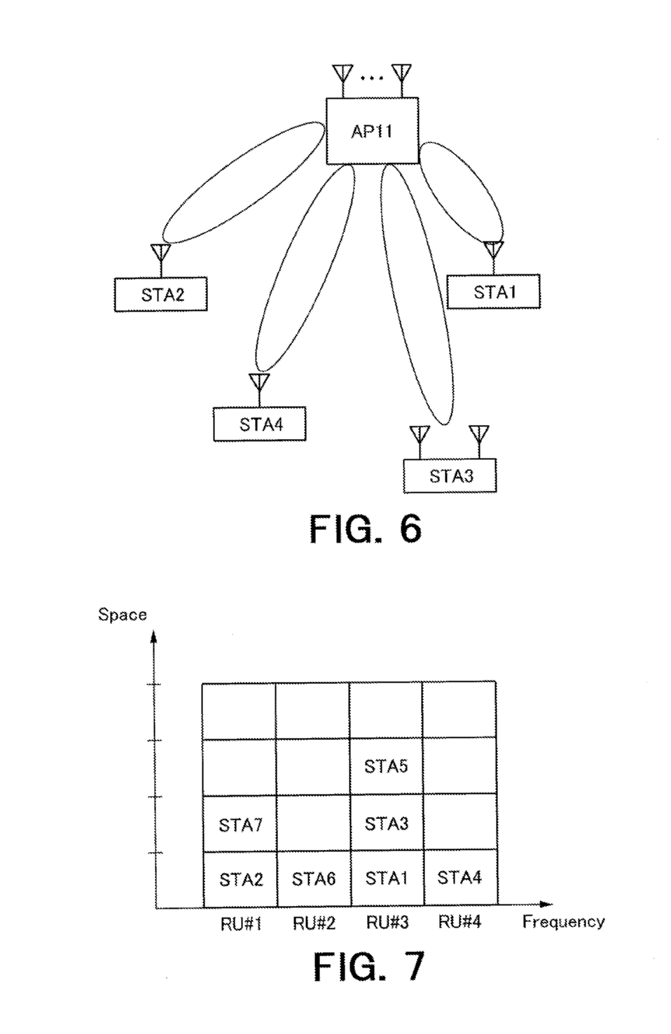

According to the DL-MU-MIMO scheme, frames are transmitted by forming beams that are spatially orthogonal with respect to a plurality of terminals, by using a technique called “beam forming”. To form the beams, channel responses of the downlinks with the terminals are used. For this reason, the access point transmits, for example, a sounding-purpose frame (e.g., a null data packet) to each of the terminals in advance so as to receive a feedback for a channel response of the downlink measured by each of the terminals. In this manner, the access point obtains the channel responses of the downlinks to the terminals. To form the beams for the terminals by using the channel responses, a well-known method may be used. For example, a weight is applied to a transmission signal to the terminal in correspondence with the antennas, so that the weighted transmission signal is transmitted from each of the antennas. This process is performed for each of the plurality of terminals, so that the signals corresponding to the antennas of the plurality of terminals are transmitted simultaneously. For each of the terminals, the weight is applied to the transmission signal in such a manner that transmission signal is properly received by the terminal and that a null signal is received (i.e., no transmission signal is received) by the other terminals. Because DL-MU-MIMO is defined by the IEEE 802.11ac standard, it is also acceptable to use the definition of the standard. FIG. 6 schematically illustrates how the access point 11 performs a DL-MU-MIMO communication with four terminals, namely the terminals 1 to 4. The access point 11 forms beams that are spatially orthogonal with respect to each of the terminals 1 to 4. The terminals 5 to 10 are omitted from the drawing. In the DL-MU-MIMO communication also, the terminals simultaneously perform the communication with the spatial separation, by using the same frequency band as the one used by the access point, as illustrated in FIG. 4.

According to UL-OFDMA & MU-MIMO, an MU-MIMO transmission is performed while using mutually-the-same resource unit among a plurality of terminals, for each of the resource units. The plurality of terminals using mutually-the-same resource unit use mutually-different preamble signals for performing a UL-MU-MIMO transmission. Among terminals using mutually-different resource units, use of mutually-the-same preamble signal is possible without any problem.

FIG. 7 is a drawing for explaining a concept of UL-OFDMA & MU-MIMO. The access point uses four resource units, namely RU #1, RU #2, RU #3, and RU #4. Let us discuss a situation where there are seven terminals, namely the terminals 1 to 7. The resource units are expressed as RU #1 to RU #4 for the sake of convenience and do not necessarily have to correspond to those in FIG. 3. The access point allocates the terminals 2 and 7 to the resource unit RU #1, allocates the terminal 6 to the resource unit RU #2, allocates the terminals 1, 3, and 5 to the resource unit RU #3, and allocates the terminal 4 to the resource unit RU #4. Alternatively, any single terminal may be allocated to a plurality of resource units. In the example in FIG. 7, the terminals simultaneously transmit frames while the terminals 2 and 7 are using the resource unit RU #1, the terminal 6 is using the resource unit RU #2, the terminals 1, 3, and 5 are using the resource unit RU #3, and the terminal 4 is using the resource unit RU #4. In each of the resource units, a UL-MU-MIMO communication is performed so as to transmit a plurality of frames to which mutually-orthogonal preamble signals are set. Because there is only one terminal for each of the resource units RU #2 and RU #4, it is acceptable to use an arbitrary preamble signal, and it is also acceptable to transmit a frame to which a physical header not compliant with UL-MU-MIMO is set. When UL-OFDMA & MU-MIMO is used, it is possible to multiplex a larger number of terminals than when either UL-OFDMA or UL-MU-MIMO is used alone.

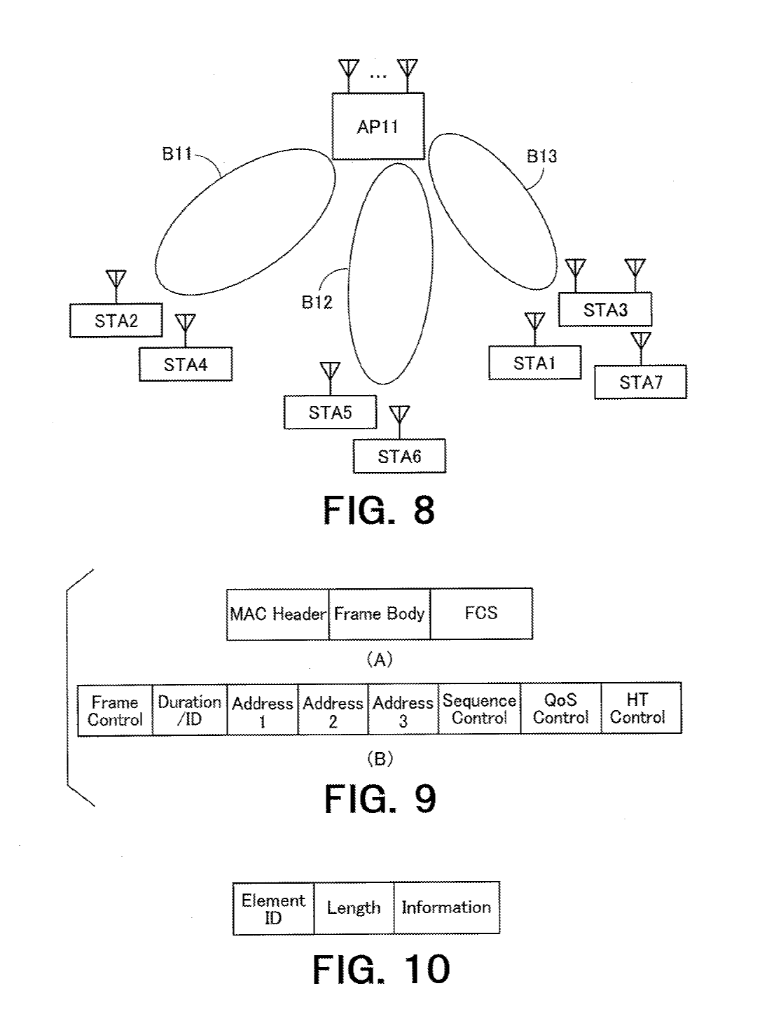

According to DL-OFDMA & MU-MIMO, a plurality of terminals are divided (grouped) into a plurality of groups, and a beam is formed for each of the groups, so that each of the beams realizes a DL-OFDMA communication with the plurality of terminals belonging to the corresponding group. FIG. 8 is a drawing for explaining a concept of DL-OFDMA & MU-MIMO. The access point generates a beam B11 used in common by a group made up of the terminals 2 and 4, generates a beam B12 used in common by a group made up of the terminals 5 and 6, and generates a beam B13 used in common by a group made up of the terminals 1, 3, and 7. The beam B11 realizes a DL-OFDMA transmission to the terminals 2 and 4. In other words, for the frames addressed to the terminals 2 and 4, signals having a channel width, to which mutually-different resource units are allocated are transmitted, so that the terminals 2 and 4 each extract and decode the signal having the resource unit thereof from the signal and obtains the frame addressed thereto. The beam B12 and the beam B13 similarly realize a DL-OFDMA transmission to the terminals 5 and 6 and a DL-OFDMA transmission to the terminals 1, 3, and 7, respectively. The method for organizing the plurality of terminals into the plurality of groups and the method for forming the beam for each of the groups may arbitrarily be selected. For example, it is acceptable to obtain, through a sounding process or the like, a channel response of the downlink of each of the terminals, so as to put together terminals having close channel responses into a group. Alternatively, it is also possible to measure the distance and the orientation for each of the terminals, so as to put together terminals having similar distances and orientations into a group. It is acceptable to use any other method for organizing the terminals into groups. To form the beam of each of the groups, it is also acceptable, for example, to use one of the terminals belonging to a group as a representative terminal and to generate the beam of the group based on a channel response of the downlink to the representative terminal. Alternatively, it is also acceptable to generate a beam for each of the groups by using channel responses of the downlinks to all or the plurality of terminals belonging to the group. It is also acceptable to generate the beam for each of the groups by using any other method.

FIG. 9(A) illustrates the basic exemplary format of the MAC frame. The data frame, the management frame, and the control frame in accordance with this embodiment are based on a frame format of this type. The management frame is for use in management of communication link with another terminal. The data frame is for use in transmission of data to another terminal in a state where the communication link is established with the other terminal. The control frame is for use in control in transmission and reception (exchange) of the management frame and the data frame to/from (with) another wireless communication device. The detail of each type of frame is described in other embodiments as discussed later.

This frame format of FIG. 9(A) includes the fields of MAC header, Frame body, and FCS. The MAC header includes, as illustrated in FIG. 9(B), the fields of Frame Control, Duration/ID, Address 1, Address 2, Address 3, Sequence Control, QoS Control, and HT (High Throughput) Control.

These fields do not need to always exist and there may be cases where some of these fields do not exist. For example, there may be a case where the Address 3 field does not exist. Also, there may be other cases where both or either one of the QoS Control field and the HT Control field does not exist. Also, there may be still other cases where the frame body field does not exist. Also, any field or fields that are not illustrated in FIG. 9(B) may exist. For example, an Address 4 field may further exist. Also, a control field (trigger information field) as a novel field according to the present embodiment may be provided. The control field may be called HE control field. The HE control field may be an extended field of the HT control field.

The field of Address 1 indicates Receiver Address (RA), the field of Address 2 indicates Transmitter Address (TA), and the field of Address 3 indicates either BSSID (Basic Service Set Identifier) (which may be the wildcard BSSID whose bits are all set to 1 to cover all of the BSSIDs depending on the cases) which is the identifier of the BSS, or TA, depending on the purpose of the frame.

As described above, two fields of Type and Subtype (Subtype) or the like are set in the Frame Control field. The rough classification as to whether it is the data frame, the management frame, or the control frame is made by the Type field, and more specific types, for example, fine discrimination among the roughly classified frames, for example, as to whether it is a BA (Block Ack) frame, a BAR (Block Ack Request) frame or CTS (Clear to Send) frame within the control frame, or a beacon frame within the management frame is made by the Subtype field. The trigger frame which will be described later may also be discriminated by the combination of the Type and the Subtype. It is likely that the trigger frame is categorized as the control frame.

The Duration/ID field stores the medium reserve time therein, and it is determined that the medium is virtually in the busy state from the end of the physical packet including this MAC frame to the medium reserve time when a MAC frame addressed to another terminal is received. The scheme of this type to virtually determine that the medium is in the busy state, or the period during which the medium is virtually regarded as being in the busy state, is, as described above, called NAV (Network Allocation Vector). The QoS field is used to carry out QoS control to carry out transmission with the priorities of the frames taken into account. The HT Control field is a field introduced in the IEEE802.11n.

In the management frame, an information element (Information element; IE) to which a unique Element ID (Identifier) is assigned is set in the Frame Body field. One or a plurality of information elements subsequent to a specific field depending on the type of the management frame may be set in the frame body field. The information element has, as illustrated in FIG. 10, the fields of an Element ID field, a Length field, and an Information field. The information element is discriminated by the Element ID. The Information field is adapted to store the content of the information to be notified, and the Length field is adapted to store the length information of the information field.

Frame check sequence (FCS) information is set in the FCS field as a checksum code for use in error detection of the frame on the reception side. As an example of the FCS information, CRC (Cyclic Redundancy Code) may be mentioned.

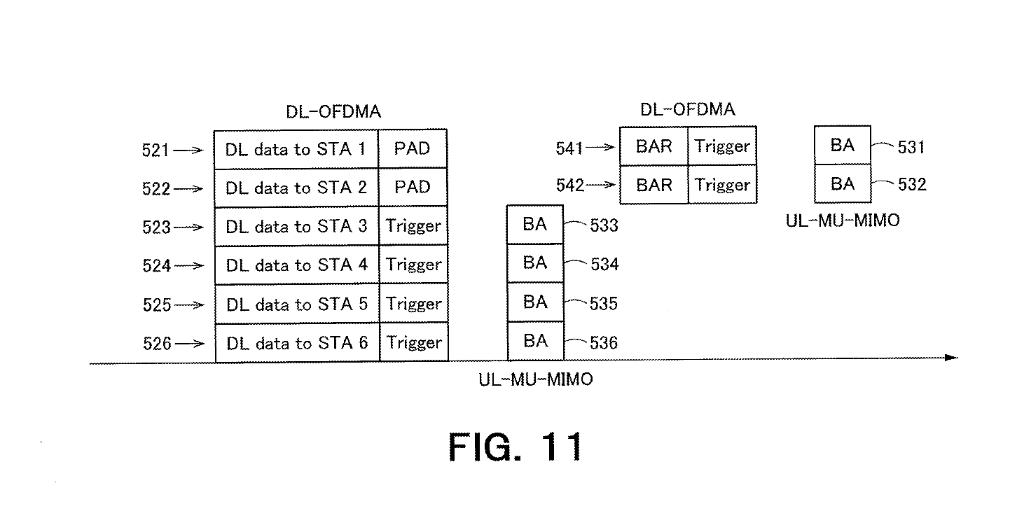

FIG. 11 illustrates a first sequence example of operations performed by the access point 11 and the plurality of terminals according to the first embodiment. The present sequence is characterized in that the access point transmits frames (aggregated frames each containing a plurality of data frames (each aggregated frame in the aggregated frame may be called a subframe), in the present example)) to the terminals 1 to 6 by DL-OFDMA, and acknowledgement responses from the terminals 1 to 6 are realized in two separate UL-MU transmissions, namely a UL-MU-MIMO transmission of Block Ack (BA) frames from the terminals 3 to 6 and a UL-MU-MIMO transmission of BA frames from the terminals 1 and 2. In the present example, it is assumed that the maximum possible multiplexing number for the DL-OFDMA communication is larger than the maximum possible multiplexing number for the UL-MU-MIMO communication. In this situation, it would be impossible to transmit, in a multiplexed manner, all the BA frames from the terminals 1 to 6 in a UL-MU-MIMO transmission at one time. For this reason, in the present sequence, the multiplexing transmission of the BA frames from the terminals 1 to 6 is divided into two UL-MU communications. The present sequence will be explained in detail below.

Before the present sequence is started, in an example, a communication (a single user communication) is individually performed with a CSMA/CA-based method, between the access point and a part or all of the terminals 1 to 10. During the single user communication, for example, the communication is performed between the access point and each of the terminals by using a channel having a basic channel width (e.g., 20 MHz). In one example of the single user communication, when a terminal stores therein data for an uplink transmission, the terminal acquires an access right to a wireless medium according to CSMA/CA. Accordingly, the terminal performs a carrier sense process for a carrier sensing period (a stand-by time period) obtained by adding together a Distributed coordination function InterFrame Space (DIFS)/Arbitration InterFrame Space (AIFS) period and a back-off period randomly determined. When the medium (CCA) is determined to be idle, the terminal acquires an access right to transmit one frame, for example. The expression “DIFS/AIFS” denotes one selected from between DIFS and AIFS. When communication is not QoS compatible, DIFS is specified, whereas when communication is QoS compatible AIFS is specified, which is determined in accordance with the Access Category (AC) of the data to be transmitted. The DIFS period and the AIFS period are merely examples. It is acceptable to use any other time period as long as the time period is a fixed time period determined in advance. The same applies to the other DIFS and AIFS periods mentioned in elsewhere in the present description. The access right may be acquired by transmitting and receiving a Request to Send (RTS) frame and a Clear to Send (CTS) frame, as defined in the IEEE 802.11 standard.

When having acquired the access right, the terminal transmits a data frame containing the data to be transmitted (more specifically, a physical packet containing the data frame). When the access point has properly received the data frame, the access point returns an ACK frame (more specifically, a physical packet containing the ACK frame) serving as an acknowledgement response frame, when a time period corresponding to a Short InterFrame Space (SIFS) period has elapsed since the receiving of the data frame is completed. By receiving the ACK frame, the terminal determines that the transmission of the data frame was successful. The SIFS period is merely an example. It is acceptable to use any other time period, as long as the time period is a fixed time period determined in advance. The same applies to the other SIFS periods mentioned elsewhere in the present description.

The data frame transmitted to the access point may be an aggregated frame (e.g., A-Medium Access Control (MAC) Protocol Data Unit (A-MPDU) or the like) aggregating a plurality of data frames (subframes). In that situation, the acknowledgement response frame sent as a response from the access point may be a Block Ack (BA) frame (The same applies hereinafter). As stated above, each of the frames contained in the aggregated frame may be referred to as a sub-frame.

In this situation, the access point determines that DL-OFDMA communication should be started with arbitrary timing. In the present example, it is assumed that a DL-OFDMA transmission is performed in the same channel (the one channel having the basic channel width, which is 20 MHz) as the channel used in the single user communication. In other words, it is assumed that the DL-OFDMA transmission is performed by using a plurality of resource units defined within the channel having the basic channel width of 20 MHz. It should be noted, however, that it is also possible to perform the DL-OFDMA transmission by using another channel width such as 40 MHz, 80 MHz, or the like.

Let us discuss an example in which the access point 11 has pieces of data addressed to the terminals 1 to 6 and has determined that the pieces of data are to be transmitted to the terminals 1 to 6 by DL-OFDMA. The access point 11 determines each of the resource units to be used in the transmissions to the terminals 1 to 6. The access point 11 generates an aggregated frame 521 aggregating a plurality of data frames with data addressed to the terminal 1, an aggregated frame 522 aggregating a plurality of data frames containing the data addressed to the terminal 2, an aggregated frame 523 aggregating a plurality of data frames containing the data addressed to the terminal 3 and a trigger frame, an aggregated frame 524 aggregating a plurality of data frames containing the data addressed to the terminal 4 and a trigger frame, an aggregated frame 525 aggregating a plurality of data frames containing the data addressed to the terminal 5 and a trigger frame, and an aggregated frame 526 aggregating a plurality of data frames containing the data addressed to the terminal 6 and a trigger frame. Padding data is added to the tail end of each of the aggregated frames 521 and 522, so as to arrange the packet length thereof to be equal to the packet length of each of the aggregated frames 523 to 526. However, the padding data does not necessarily have to be added thereto. The access point 11 transmits the aggregated frames 521 to 526 for the terminals by OFDMA, on the basis of an access right to a wireless medium acquired according to CSMA/CA, for example. More specifically, the access point transmits the aggregated frames after setting a physical header to each of the aggregated frames. In a predetermined field (which will be referred to as a SIG1 field in the present example) of the physical header, an identifier of the resource unit that should be received may be designated, for the corresponding one of the terminals. With this arrangement, each of the terminals is able to identify the resource unit that should be received thereby.

The trigger frame according to the present embodiment corresponds to a frame instructing a transmission of a frame such as an acknowledgement response frame. In the present embodiment, it is assumed that the trigger frame instructs a transmission of the acknowledgement response frame (e.g., the BA frame); however, the frame of which a transmission is instructed is not limited to this example.

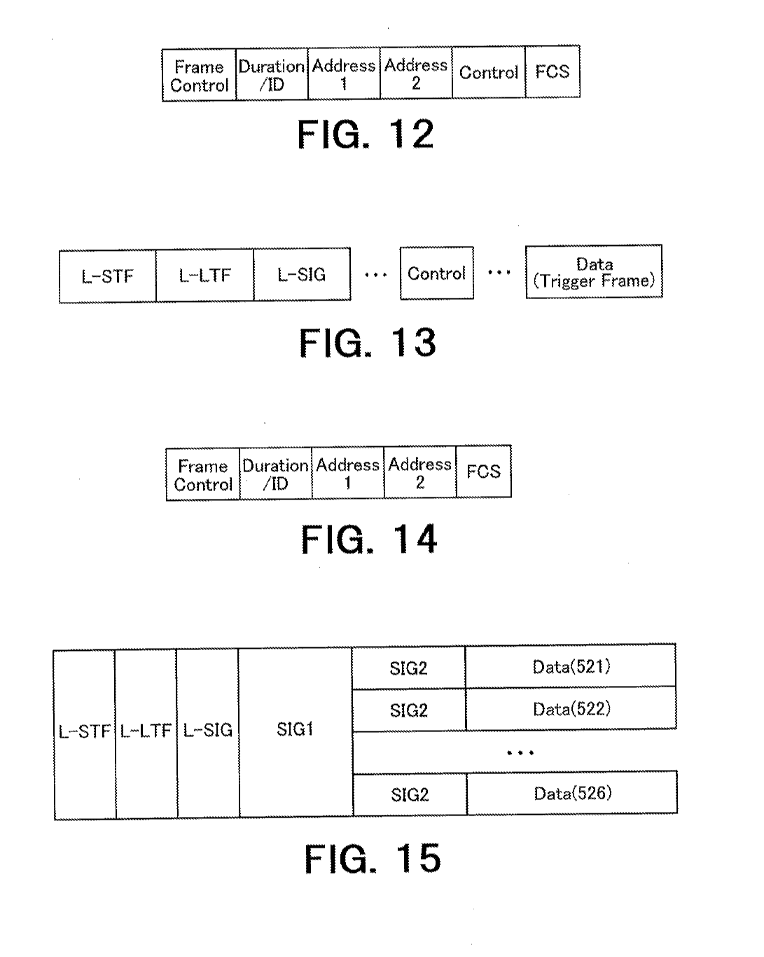

FIG. 12 illustrates an example of a format of the trigger frame. The trigger frame is defined based on a MAC frame format generally used as illustrated in FIG. 9. A control field is provided in either a MAC header or a frame body field of the trigger frame.

The type of the “Frame Control” field may be a value indicating the control frame. The value of the sub-type may be a value newly defined for the trigger frame. It should be noted, however, that the possibility of having another configuration is not excluded where the frame type of the trigger frame is not a control frame, but is a management frame or a data frame. It is also acceptable to add, as an information element, information (information about the control field) necessary for fulfilling the role of a trigger frame, to the frame body field of an existing management frame. The value of the sub-type does not necessarily have to be newly defined and may conveniently use a value of an existing standard.

The RA (the receiver address) of the trigger frame may be, for example, a unicast address, a broadcast address, or a multi-cast address, depending on the receiver. Such an address may be configured in the “Address 1” field. Further, the TA (the transmitter address) may be a MAC address or a BSSID of the access point configured into the “Address 2” field.

In the control field, information that is necessary when the terminal performs an uplink transmission is configured. For example, information designating a communication resource (a preamble signal, a resource unit, or the like) to be used in the uplink communication may be configured therein. Further, information designating the type of the frame to be transmitted in the uplink transmission may be configured therein. Further, information designating the timing with which the uplink transmission is to be performed may be configured therein. It is also acceptable to configure therein information designating the communication scheme (UL-OFDMA, UL-MU-MIMO, or UL-OFDMA & MU-MIMO) of the uplink transmission.

The example in FIG. 12 illustrates an example in which the control field is configured in either the MAC header or the frame body field; however, the control field may be arranged in a physical header, as illustrated in FIG. 13. The physical header illustrated in FIG. 13 contains the control field positioned to the rear of a Legacy-Short Training Field (L-STF), a Legacy-Long Training Field (L-LTF), and a Legacy Signal Field (L-SIG).

Further, as illustrated in FIG. 14, the trigger frame may have a configuration from which the control field is omitted. In that situation, the control field is not present in the physical header, either. This configuration is possible when the information necessary for the uplink transmission (e.g., the communication resource to be used in the uplink transmission) is known to the terminal in advance. In that situation, the trigger frame functions as a frame that signifies instructing the terminal to perform the uplink transmission. The trigger frame may be recognized, as explained above, from the type or the sub-type of the “Frame Control” field.

FIG. 15 illustrates an example of a configuration of a physical packet used when the aggregated frames 521 to 526 are transmitted by DL-OFDMA. The L-STF, L-LTF, and L-SIG fields explained with reference to FIG. 5 may be transmitted by using a 20 MHz channel width, in one example, and each have mutually-the-same value (a bit string) configured therein in all of the aggregated frames 521 to 526. To designate a resource unit to be used by each of the terminals, the SIG1 field has therein information in which identifiers of the terminals and numbers (i.e., identifiers) of the resource units are associated with each other. The identifier of the terminal may be an Association ID (AID), a part of an AID (a partial AID), or any other identifier such as a MAC address. The Association ID is an identifier that is assigned at the time of an association process performed by a terminal with the access point for the purpose of belonging to a BSS of the access point.

The SIG1 field is also transmitted by using a 20 MHz channel width and has mutually-the-same value (a bit string) configured therein in all of the aggregated frames 521 to 526. Each of all the terminals 1 to 6 is capable of decoding the SIG1 field. The SIG2 field is configured individually for each of the resource units and may have therein information necessary for decoding the data field, such as an MCS (Modulation and Coding Scheme). Accordingly, when having received a signal from the access point 11, each of the terminals is able to understand the resource unit that should be decoded thereby, by decoding the SIG1 field.

The terminals 1 to 6 receive the aggregated frames 521 to 526, respectively, by decoding the signal of the designated resource unit. The terminals 1 and 2 decode the plurality of data frames (subframes) in the aggregated frames 521 and 522, perform a CRC check process, and judge whether the plurality of data frames have successfully been received. The terminals 3 to 6 decode the plurality of data frames (subframes) and the trigger frame in the aggregated frames 523 to 526, perform a CRC check process, and judge whether the plurality of data frames have successfully been received and whether the trigger frames have successfully been received. It is assumed that the receptions of the trigger frames have all been successful. It is also assumed that the RA's of the trigger frames in the aggregated frames 523 to 526 are the MAC addresses of the terminals 3 to 6.

The terminals 3 to 6 instructed by the trigger frames to transmit an acknowledgement response frame each generate a BA frame containing information indicating whether the plurality of data frames have successfully been received and transmit the generated BA frames when a predetermined time period has elapsed since the receiving of the aggregated frames 523 to 526 is completed. More specifically, each of the terminals 3 to 6 identifies the preamble signal designated thereto on the basis of the trigger frame, obtains a physical packet by adding a physical header in which the preamble signal is configured in a corresponding field to the BA frame, and transmits the physical packet. As a result, the physical packets containing the BA frames are transmitted from the plurality of terminals by UL-MU-MIMO. The access point may, in advance, notifies he preamble signal via a management frame or the like, instead of designating the preamble signal in the trigger frame. In that situation, the access point determines the plurality of terminals to which the trigger frames are transmitted in such a manner that the plurality of terminals of which at least the preamble signals are mutually orthogonal perform the UL-MU-MIMO transmission.

In this situation, the predetermined time period may be an IFS period [μs] defined in advance, or may be, in another example, an SIFS period (=16 μs) that is an inter-frame time interval defined in a MAC protocol specification for a wireless LAN by IEEE 802.11, or may be a value larger or smaller than the SIFS period. The time period may be designated in the trigger frame. Alternatively, the time period may be provided in a notification in advance, via a beacon frame or another management frame.

The frames transmitted to the terminals 3 to 6 may be frames having mutually-different contents or may be frames having mutually-the-same contents. In the general expression “the access point or the plurality of terminals transmit or receive an X-th frame”, the contents of the X-th frame may be the same or may be different. The X is an arbitrary value.

The access point spatially separates BA frames 533 to 536 from the terminals 3 to 6 from one another by using the preamble signals contained in the physical packets received from the terminals 3 to 6 so as to receive the separated BA frames 533 to 536. On the basis of the BA frames 533 to 536, the access point judges whether the plurality of data frames transmitted to each of the terminals 3 to 6 have successfully been transmitted.

Further, when a predetermined time period has elapsed since the receiving of the BA frames 533 to 536 is completed, the access point transmits, by an OFDMA transmission, aggregated frames 541 and 542 each aggregating a Block Ack Request (BAR) frame and a trigger frame to the terminals 1 and 2. More specifically, the access point transmits the aggregated frames after adding a physical header to each of the aggregated frames. The resource units used for transmitting the aggregated frames 541 and 542 may be the same as, or may be different from, the resource units previously used for transmitting the aggregated frames 521 and 522 to the terminals 1 and 2. In a predetermined field (the SIG1 field in the present example) of the physical header, an identifier of the resource unit that should be received is designated, for the corresponding one of the terminals. When there is a rule indicating that the same resource units as those used for the aggregated frames 521 and 522 should be used, it is also acceptable to omit the designation of the identifiers of the resource units. Incidentally, it is also acceptable to transmit, at the same time as the transmission of the aggregated frames 541 and 542, a frame addressed to another terminal, by using a resource unit other than the resource units used in transmitting the aggregated frames 541 and 542.

In this situation, the predetermined time period to stand by between when the receiving of the BA frames 533 to 536 is completed and when the aggregated frames 541 and 542 are transmitted may be an SIFS period or may be a time period longer or shorter than the SIFS period. The BAR frame is a frame requesting that a BA frame be transmitted and contains a start sequence number as information identifying a frame for which an acknowledgement (whether the communication was successful or not) is to be made. This configuration means that it is requested that the acknowledgement (whether the communication was successful or not) be transmitted with respect to the frame identified with the start sequence number and the frames thereafter. In the present example, the BAR frames are transmitted when the predetermined time period has elapsed since the receiving of the BA frames 533 to 536 is completed; however, it is also acceptable to transmit the BAR frames by acquiring an access right by performing a carrier sensing process with a CSMA/CA-based method.

The terminals 1 and 2 receive the aggregated frames 541 and 542, respectively. Having been instructed by the trigger frames in the aggregated frames 541 and 542 to transmit an acknowledgement response frame, the terminals 1 and 2 generate BA frames 531 and 532, respectively, containing information indicating whether or not the plurality of data frames contained in the aggregated frames 521 and 522 have successfully been received. After that, the terminals 1 and 2 transmit the BA frames 531 and 532, respectively, when a predetermined time period has elapsed since the receiving of the aggregated frames 541 and 542 is completed. More specifically, each of the terminals 1 and 2 identifies the preamble signal designated thereto on the basis of the trigger frame, obtains a physical packet by adding a physical header in which the preamble signal is configured in a corresponding field to a corresponding one of the BA frames 531 and 532, and transmits the physical packet. Accordingly, the BA frames are transmitted from the terminals 1 and 2 by UL-MU-MIMO. In this situation, as mentioned above, it is also acceptable to use another method by which the terminals are notified the preamble signals in advance, instead of the preamble signals being designated in the trigger frames.

When the sequence described above is used, when the user multiplexing number of the DL-OFDMA communication performed for the first time is larger than the maximum possible multiplexing number of the UL-MU-MIMO communication, the plurality of frames to be transmitted to the plurality of terminals are divided into the plurality of groups, and the control is performed so that the acknowledgement response frames (the BA frames in the present example) are sequentially transmitted for each of the groups by UL-MU-MIMO. With this arrangement, even when the multiplexing number of the downlinks is larger than the maximum possible multiplexing number of the uplinks, it is possible to cause the plurality of terminals to transmit the acknowledgement response frames efficiently.

Although it is assumed above that the multiplexing number of the downlinks is larger than the maximum possible multiplexing number of the uplinks, even when no such condition is present, the acknowledgement response frames may be divided into a plurality of groups so as to be transmitted by a UL-MU (an uplink multiplexing transmission). For example, when a DL-OFDMA communication is performed while the multiplexing number is 6, even if the maximum possible multiplexing number in a UL-MU-MIMO is 6, a three-multiplexing UL-MU-MIMO may be performed in two separate transmissions. In a UL-MU-MIMO communication, the larger the multiplexing number is, the larger the inter-user interference becomes. Accordingly, by performing the UL-MU-MIMO transmission twice with a smaller multiplexing number, it is possible to transmit the acknowledgement response frames with higher certainty.

In the sequence described above, it is assumed that the terminals 3 to 6 successfully receive the trigger frames in the DL-OFDMA transmission performed for the first time. However, if any of the terminals fails to receive the trigger frame, the terminal does not transmit the BA frame. In that situation, because the access point is not able to receive the BA frame from the failed terminal, the access point may thereafter transmit an aggregated frame aggregating a BAR frame and a trigger frame to the terminal, in the same manner as with the terminals 1 and 2.

In the sequence described above, in the DL-OFDMA transmission performed for the second time, the BAR frames and the trigger frames are aggregated in the aggregated frames. However, another configuration is also possible in which, when the parameter information necessary for the uplink transmissions (e.g., the preamble signals used in the uplink transmissions) is known to the terminals 1 and 2, the transmission of the trigger frames is omitted, so as to transmit only the BAR frames (more specifically, the physical packets obtained by adding physical headers to the BAR frames).

In the sequence described above, the terminals 1 and 2 are configured to transmit the BA frames 531 and 532, in response to receiving the aggregated frames 541 and 542 aggregating the BAR frames and the trigger frames from the access point. However, another configuration is also acceptable in which the access point omits the transmission of the aggregated frames 541 and 542. For example, when the terminals (the terminals 1 and 2 in the present example) have determined that no trigger frame was received in the DL-OFDMA communication performed for the first time, the terminals may transmit the BA frames 531 and 532, when a time period obtained by summing the SIFS period, the BA frame length (the physical packet length in actuality) period and the SIFS period has elapsed. It is assumed in this situation, however, that the terminals 1 and 2 are notified, in advance, the preamble signals to be used in the uplink transmissions. By using this configuration also, it is possible to arrange the UL-MU-MIMO transmission by the terminals 3 to 6 to be temporally staggered (i.e., to be temporally not overlapped) from the UL-MU-MIMO transmission by the terminals 1 and 2.

In the sequence described above, only the BA frames are transmitted from the terminals 3 to 6 in the UL-MU-MIMO transmission performed for the first time and from the terminals 1 and 2 in the UL-MU-MIMO transmission performed for the second time. However, another configuration is acceptable in which aggregated frames each aggregating a BA frame and one or more other frames are transmitted each time.

In the sequence described above, the access point divides the terminals into the group made up of the terminals 1 and 2 (more specifically, the group made up of the frames to be transmitted to the terminals 1 and 2) and the group made up of the terminals 3 to 6 (more specifically, the group made up of the frames to be transmitted to the terminals 3 to 6); however, the method for dividing the terminals into groups is not limited to this example. For instance, the frames may be divided into a group made up of the frames to be transmitted to the terminals 1, 3, and 5 and a group made up of the frames to be transmitted to the terminals 2, 4, and 6. As for a criterion used for dividing the frames, it is also acceptable to generate a plurality of groups in such a manner that frames transmitted by terminals having a low correlation with one another in the UL-MU-MIMO transmission are organized into mutually the same group. It is also acceptable to generate a plurality of groups randomly. It is also acceptable to transmit a plurality of frames (each of which is the aggregated frame, in the present example) from a single terminal by using a plurality of resource units. In that situation, an arrangement is acceptable in which a plurality of aggregated frames to be transmitted to a single terminal belong to mutually-different groups, respectively.

Further, yet another arrangement is acceptable in which a plurality of frames to be transmitted to a plurality of terminals are divided into three or more groups, so that the UL-MU-MIMO transmissions are performed by being temporally staggered (i.e., not overlapped) for each of the groups. In one example, when the multiplexing number of a DL-OFDMA communication is M1, whereas the maximum possible multiplexing number of a UL-MU-MIMO communication is M2, it is necessary to generate groups a number (or quantity) of which is equal to, at least, a value obtained by adding 1 to the quotient calculated by dividing M1 by M2 (i.e., a value obtained by rounding up the result of M1/M2).

In the sequence described above, the plurality of data frames are transmitted to the terminals by DL-OFDMA, as being contained in the aggregated frames 521 to 526; however, the quantity of the data frames to be transmitted may be one. In that situation, because no trigger frame is transmitted to the terminals 1 and 2, a single data frame may be transmitted thereto, instead of the aggregated frame (it is also acceptable to add padding data to the tail end of the data frame). Even when a single data frame is transmitted in this manner, it is also possible to use a BA frame as an acknowledgement response frame.

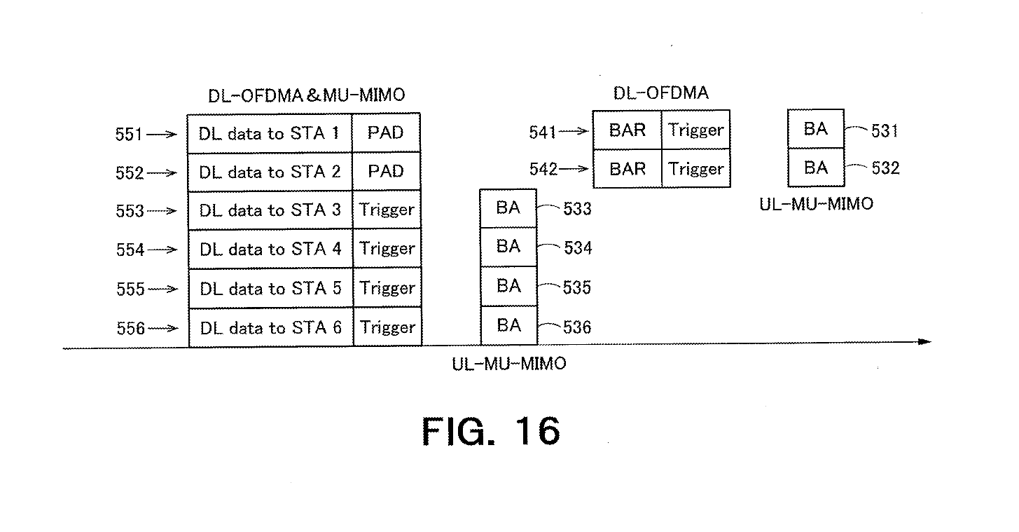

FIG. 16 illustrates a second sequence example of operations performed by the access point 11 and a plurality of terminals according to the present embodiment. In the first sequence example in FIG. 11, the DL-MU transmission to the terminals 1 to 6 is a DL-OFDMA communication. In contrast, in the present sequence example, a DL-OFDMA & MU-MIMO (see FIG. 8) communication is performed instead. In other words, the access point transmits aggregated frames 551 to 556 to the terminals 1 to 6, respectively, by DL-OFDMA & MU-MIMO. The configurations of the aggregated frames 551 to 556 are the same as those of the aggregated frames 521 to 526 illustrated in FIG. 11. In other words, each of the aggregated frames addressed to the terminals 1 and 2 contains no trigger frame, whereas each of the aggregated frames addressed to the terminals 3 to 6 contains a trigger frame.

The aggregated frames 521 to 526 to be transmitted to the terminals 1 to 6 are divided into a plurality of groups, so that a beam (a wireless signal having directivity) is formed for each of the groups. Mutually-the-same beams are formed for the terminals to which frames belonging to mutually-the-same group are to be transmitted, so that a DL-OFDMA communication is performed for each of the beams. For example, the frames are divided into a group made up of the frames to be transmitted to the terminals 1 and 2 and a group made up of the frames to be transmitted to the terminals 3 to 6, so that a beam is formed for each of the groups. With each of the beams, physical packets that have a format illustrated in FIG. 15 and is addressed to the plurality of terminals is transmitted (by a DL-OFDMA transmission). In this situation, because the beams are spatially separated from one another, mutually-the-same resource unit may be used among mutually-different beams. The operations performed after the DL-OFDMA & MU-MIMO transmission is the same as those illustrated in FIG. 11. The aggregated frames 541 and 542 transmitted to the terminals 1 and 2 may be transmitted by DL-OFDMA & MU-MIMO or may be transmitted by DL-MU-MIMO, instead of by DL-OFDMA.

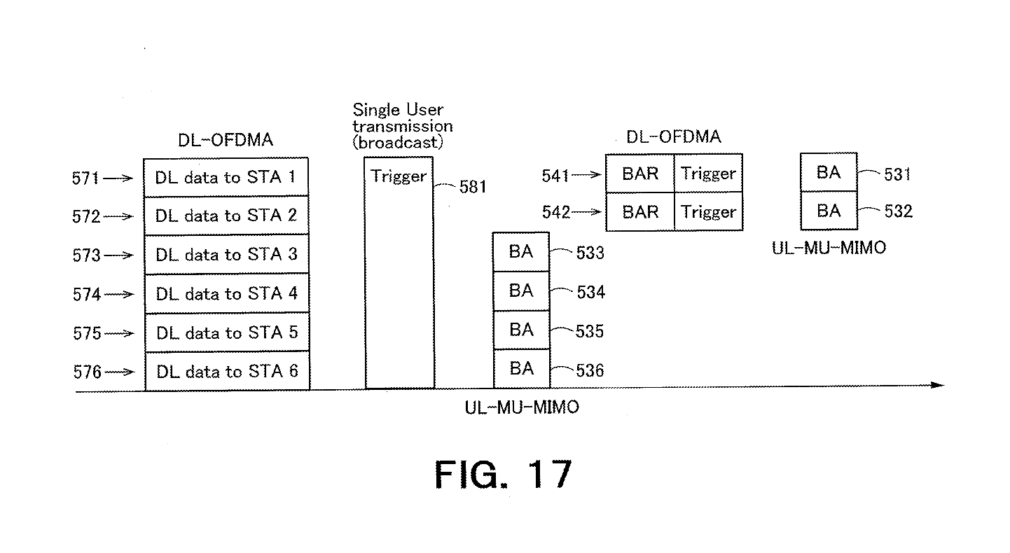

FIG. 17 illustrates a third sequence example of operations performed by the access point 11 and a plurality of terminals according to the present embodiment. In the present sequence example, aggregated frames 571 to 576 aggregating a plurality of data frames are transmitted to the terminals 1 to 6, respectively, by DL-OFDMA. In the first sequence example illustrated in FIG. 11, each of the aggregated frames addressed to the terminals 3 to 6 contains a trigger frame. In contrast, in the present sequence example, none of the aggregated frames addressed to the terminals contains a trigger frame.

The access point transmits (by a single user transmission) a single trigger frame 581 by using a band having the channel width, when a predetermined time period (e.g., a SIFS period) has elapsed since the DL-OFDMA transmission of the aggregated frames 571 to 576 is completed. The RA of the trigger frame 581 may be, in an example, either a broadcast address or a multi-cast address. The control field (see FIG. 12 and FIG. 13) of the trigger frame 581 may contain, in an example, information designating the terminals 3 to 6 for which the UL-MU-MIMO communication is to be performed and information designating the preamble signals to be used by the terminals 3 to 6. The terminals 3 to 6 designated by the trigger frame 581 transmit BA frames 533 to 536 by uplink transmissions, in the same manner as illustrated in the first sequence example in FIG. 11, when a predetermined time period has elapsed since the receiving of the trigger frame 581 is completed. The predetermined time period may be an SIFS period or may be a time period determined differently. Because the terminals 1 and 2 are not designated in the trigger frame 581, the terminals 1 and 2 perform no operation in response to the trigger frame 581. The operations performed thereafter are the same as those illustrated in the first sequence example in FIG. 11.

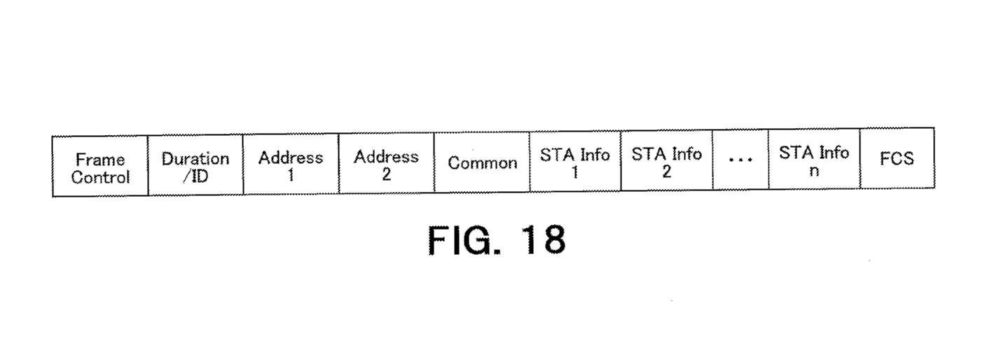

In this situation, as for the format of the trigger frame 581, the control field may be configured with a common control field and a plurality of terminal information fields (STA info. fields). An example of such a format is illustrated in FIG. 18. Information provided as a notification in common to the plurality of terminals (the terminals 3 to 6 in the present example) is configured into the common information field. For instance, examples of the configured information include the quantity of the terminal information fields, the communication scheme to be used in an uplink transmission, and information about the timing with which an uplink transmission is to be performed. Further, an identifier (e.g., a group ID defined in IEEE 802.11ac or the like) identifying the group made up of the terminals 3 to 6 may be configured therein. In each of the plurality of terminal information fields, parameter information individually provided as a notification to a corresponding one of the terminals is configured. For example, an identifier of each of the terminals may be configured therein. The identifier of each of the terminals may be an Association ID (AID), a part of an AID (a partial AID), or a MAC address. Any other value may be used as long as it is possible to identify each of the terminals. In that situation, when any of the terminals has detected a terminal information field in which the identifier thereof is set, the terminal determines that the terminal is designated to perform an uplink transmission of an acknowledgement response frame. Further, in each of the terminal information fields, it is also acceptable to set information designating a communication resource to be used in the uplink transmission performed by the corresponding one of the terminals. In addition, it is also acceptable to set information about MCS or the like to be used in the uplink transmission. Further, it is also acceptable to set an adjustment amount for predetermined timing into each of the terminal information fields (for example, the adjustment amount may be set for each of the terminals to enable the access point to receive signals from the plurality of terminals simultaneously with a high level of precision). Each of the terminals performs an uplink transmission according to the parameters set in the terminal information field in which the identifier thereof is set. In this situation, similarly to the example in FIG. 13, it is also acceptable to arrange a common control field and a plurality of terminal information fields in a physical header.

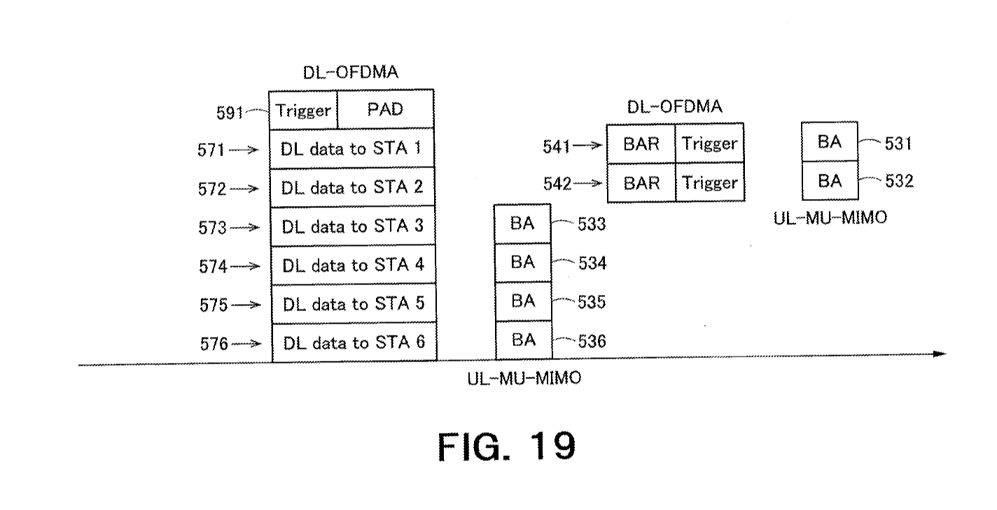

FIG. 19 illustrates a fourth sequence example of operations performed by the access point 11 and a plurality of terminals according to the present embodiment. In the present sequence example, aggregated frames 571 to 576 aggregating a plurality of data frames addressed to the terminals 1 to 6 and a trigger frame 591 are transmitted by DL-OFDMA. The RA of the trigger frame 591 may be, in an example, either a broadcast address or a multi-cast address. Padding data is added to the tail end of the trigger frame 591 so as to arrange the length thereof to be equal to the length of each of the aggregated frames 571 to 576. A part at the tail end of each of the aggregated frames 571 to 576 may be padding data (not shown).

The access point transmits the aggregated frames 571 to 576 and the trigger frame 591 by setting a physical header to each of the frames. In a predetermined field (a SIG1 field in the present example) of each of the physical headers, an identifier of the resource unit that should be received may be designated for the corresponding one of the terminals. To enable all of the terminals 1 to 6 to decode the signal of the resource unit used for transmitting the trigger frame 591, it is also acceptable to define an ID (which is referred to as either a broadcast ID or a multi-cast ID, for the sake of convenience) designating either all the terminals or terminals in a specific group and to set, into the SIG1 field, information that associates either the broadcast ID or the multi-cast ID with the resource unit used for transmitting the trigger frame 591. It is assumed that all of the terminals are configured to decode the signal of the resource unit designating the broadcast ID or the multi-cast ID. The broadcast ID or the multi-cast ID may be determined by the system or a specification. Alternatively, the access point may notify, in advance, either the broadcast ID or the multi-cast ID to the terminals belonging to the access point, by using a beacon frame or any other management frame.

In the trigger frame 591, information that is the same as the information in the trigger frame 581 in FIG. 17 is set. In other words, the RA of the trigger frame 591 may be, in an example, either a broadcast address or a multi-cast address. The trigger frame 591 contains information designating the terminals 3 to 6 for which a UL-MU-MIMO communication is to be performed and information designating the preamble signals to be used by the terminals 3 to 6. The terminals 3 to 6 designated by the trigger frame 591 transmit the BA frames 533 to 536 by an uplink transmission (a UL-MU-MIMO transmission), when a predetermined time period has elapsed since the receiving of the trigger frame 591 is completed. The predetermined time period may be an SIFS period or may be a time period having a value determined differently. Because the terminals 1 and 2 are not designated by the trigger frame 591, the terminals 1 and 2 perform no operation in response to the trigger frame 591. The operations performed thereafter are the same as those in the sequence example in FIG. 11 or FIG. 17.

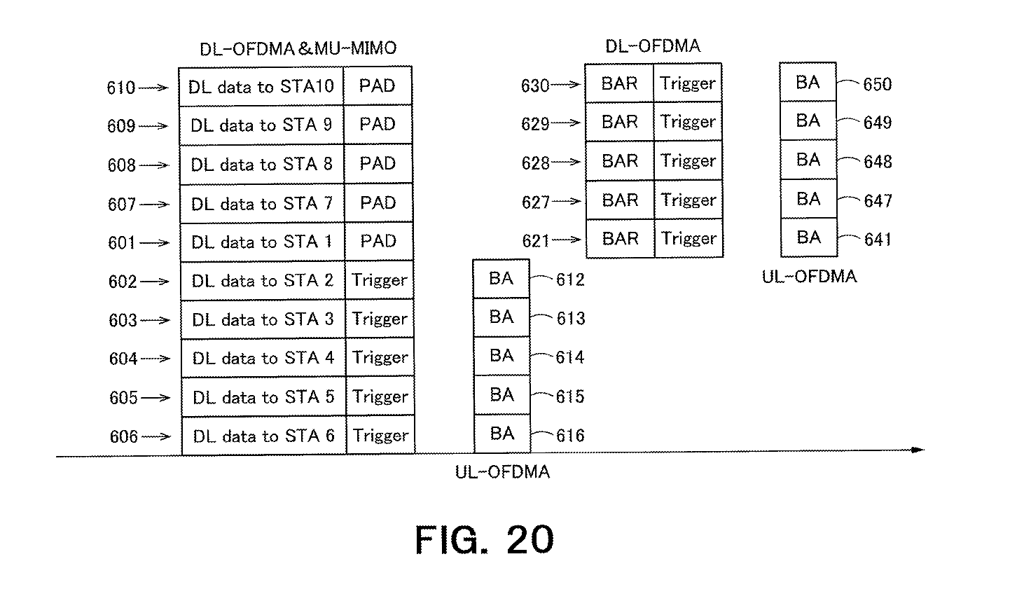

FIG. 20 illustrates a fifth sequence example of operations performed by the access point 11 and a plurality of terminals according to the present embodiment. In the first to the fourth sequence examples, the six-multiplexing DL-MU transmission is performed for the terminals 1 to 6. In contrast, in the fifth sequence example, a ten-multiplexing DL-MU transmission is performed for the terminals 1 to 10. Further, as a UL-MU transmission (an uplink multiplexing transmission) of BA frames, a UL-OFDMA communication is used, instead of the UL-MU-MIMO communication.

The access point transmits aggregated frames 601 to 610 to the terminals 1 to 10, respectively, by DL-OFDMA & MU-MIMO. In the present example, each of the aggregated frames 602 to 606 addressed to the terminals 2 to 6 contains a plurality of data frames and a trigger frame. Each of the aggregated frames 601 and 607 to 610 addressed to the terminals 1 and 7-10 contains a plurality of data frames, but contains no trigger frame.

The frames (the aggregated frames) to be transmitted to the terminals 1 to 10 are divided into a group made up of the frames to be transmitted to the terminals 1 and 7 to 10 and a group made up of the frames to be transmitted to the terminals 2 to 6, so that a beam (a wireless signal having directivity) is formed for each of the groups. Mutually-the-same beams are formed for the terminals to which frames belonging to mutually-the-same group are to be transmitted, so that a DL-OFDMA communication is performed for each of the beams. Each of the terminals 2 to 6 receives the beam signal transmitted by the DL-OFDMA, decodes the signal of the resource unit addressed thereto, and obtains a corresponding one of the aggregated frames 602 to 606. Each of the terminals 2 to 6 checks whether the plurality of data frames contained in a corresponding one of the aggregated frames 602 to 606 have successfully been received. Further, each of the terminals 2 to 6 detects the trigger frame (of which the RA is the MAC address of the terminal) addressed thereto and contained in a corresponding one of the aggregated frames 602 to 606 and determines to transmit a BA frame when a predetermined time period has elapsed since the receiving of the aggregated frames 602 to 606 is completed. Each of the terminals 2 to 6 transmits a corresponding one of the BA frames (more specifically, a physical packet obtained by adding a physical header at the head of the BA frame) 612 to 616 by using the resource unit designated by the trigger frame or the like, when the predetermined time period has elapsed since the receiving of the aggregated frames 602 to 606 is completed. In this manner, the BA frames 612 to 616 are transmitted by the UL-OFDMA.

The access point transmits, by OFDMA, aggregated frames 621 and 627 to 630 each aggregating a Block Ack Request (BAR) frame and a trigger frame, to the terminals 1 and 7 to 10, when a predetermined time period has elapsed since the receiving of the BA frames 612 to 616 is completed. More specifically, the access point transmits the aggregated frames after adding a physical header to each of the aggregated frames. The resource units used for transmitting the aggregated frames 621 and 627 to 630 may be the same as, or may be different from, the resource units previously used in transmitting the aggregated frames 601 and 607 to 610 to the terminals 1 and 7-10. In a predetermined field (the SIG1 field in the present example) of the physical header, an identifier of the resource unit that should be received is designated for the corresponding one of the terminals. When there is a rule indicating that the same resource units as those used for transmitting the aggregated frames 601 and 607 to 610 to the terminals 1 and 7-10 should be used, it is also acceptable to omit the designation of the identifiers of the resource units. Further, it is also acceptable to transmit at the same time, by an OFDMA transmission, a frame addressed to another terminal, by additionally using a resource unit other than the resource units used in transmitting the aggregated frames 621 and 627 to 630.

The terminals 1 and 7-10 receive the aggregated frames 621 and 627 to 630, respectively, by each decoding the signal of the designated resource unit. Having been instructed to transmit an acknowledgement response frame by the trigger frame contained in a corresponding one of the aggregated frames 621 and 627 to 630, each of the terminals 1 and 7-10 generates a corresponding one of BA frames 641 and 647 to 650 containing information on whether the plurality of data frames contained in the aggregated frames 601 and 607 to 610 have successfully been received and transmits the generated BA frame when a predetermined time period has elapsed since the receiving of the aggregated frames 621 and 627 to 630 is completed. More specifically, each of the terminals 1 and 7-10 identifies the resource unit designated thereto on the basis of the control field in the trigger frame and transmits a physical packet obtained by adding a physical header to a corresponding one of the BA frames 641 and 647 to 650, by using the identified resource unit. In this manner, the BA frames 641 and 647 to 650 are transmitted by UL-OFDMA. It is also acceptable to use another method by which the access point notifies, in advance, the resource units to be used for transmitting the BA frames, instead of designating the resource units in the trigger frames.

The first to the fifth sequence examples described above are merely examples of the sequence examples according to the present embodiment. It is possible to use other sequences besides these examples. For instance, the DL-OFDMA communication and the DL-OFDMA & MU-MIMO communication presented in the sequences are merely examples of downlink multiplexing transmission schemes. It is possible to substitute the DL-OFDMA communication and the DL-OFDMA & MU-MIMO communication with each other. It is also acceptable to use a DL-MIMO communication instead of these schemes. Further, the UL-OFDMA communication and the UL-MU-MIMO communication presented in the sequences are merely examples of uplink multiplexing transmission schemes. It is possible to substitute the UL-OFDMA communication and the UL-MU-MIMO communication with each other. It is also acceptable to use a UL-OFDMA & MU-MIMO communication instead of these schemes.

FIG. 21 is a functional block diagram of a wireless communication device installed in the access point 11. As mentioned above, the access point 11 is connected at least to the network provided on the terminals 1 to 10 side illustrated in FIG. 1. Also, the access point 11 may further be connected to another network. FIG. 21 illustrates a configuration of a wireless communication device connected to the network provided on the terminals 1 to 10 side.

The wireless communication device of the access point 11 includes a controller 101, a transmitter 102, a receiver 103, antennas 12A, 12B, 12C, and 12D, and a buffer 104. The quantity (i.e., number) of antennas is four in the present example; however, the wireless communication device includes at least one antenna. The controller 101 corresponds to either a controller or a baseband integrated circuit or controlling circuitry configured to control the communication with the terminals. The transmitter 102 and the receiver 103 form either a wireless communicator or an RF integrated circuit configured to transmit and receive frames via the antennas. All or a part of the processes performed by the controller 101 and the processes performed by digital domains of the transmitter 102 and the receiver 103 may be realized by software (a program) operated by a processor such as a CPU, may be realized by hardware, or may be realized by both the software and the hardware. The access point may include a processor that performs all or a part of the processes of the controller 101, the transmitter 102, and the receiver 103.

The buffer 104 is a storage configured to transfer the frames and the like between an upper layer and the controller 101. The buffer 104 may be a volatile memory such as a DRAM or may be a non-volatile memory such as a NAND, a MRAM, or the like. The upper layer may store either a frame or data received from another network into the buffer 104 so as to relay the frame or the data to the network provided on the terminals 1 to 8 side. Further, the upper layer may receive a frame or data received from a network provided on the terminals side, from the controller 101 via the buffer 104. The upper layer may perform a communication process in a layer upper than the MAC layer, such as a TCP/IP or UDP/IP communication process. Alternatively, a TCP/IP or UDP/IP communication process may be performed by the controller 101, so that the upper layer performs a process in an application layer upper than the TCP/IP or UDP/IP. The operations of the upper layer may be realized as a result of software (a program) being processed by a processor such as a CPU, may be realized by hardware, or may be realized by both software and hardware.

The controller 101 is primarily configured to perform a part of processes of the MAC layer and processes of the physical layer (e.g., processes including the processes related to the OFDMA, MU-MIMO, and OFDMA & MU-MIMO communications). By transmitting and receiving frames via the transmitter 102 and the receiver 103, the controller 101 is configured to control the communication with the terminals. Further, the controller 101 may perform control so as to transmit a beacon frame for the purpose of periodically notifying attributes and synchronization information of a Basic Service Set (BSS) of the access point. Further, the controller 101 may include a clock generator configured to generate a clock, so that the time in the device is managed by using the clock generated by the clock generator. The controller 101 may output the clock generated by the clock generator to the outside thereof. Alternatively, the controller 101 may receive an input of a clock generated by a clock generator provided on the outside thereof so as to manage the time in the device by using the clock.

The controller 101 is configured to receive an association request from any of the terminals, to perform an association process, and to establish a wireless link with the terminal by exchanging necessary information such as capabilities, attributes, and the like of each other (which may include capability information indicating whether each of the OFDMA, MU-MIMO, OFDMA & MU-MIMO schemes is executable). As necessary, the controller 101 may perform an authentication process with the terminal prior to the association process. By periodically checking on the buffer 104, the controller 101 finds out the state of the buffer 104, such as whether there is any data addressed to the terminals or not. Alternatively, the controller 101 may check the state of the buffer 104 on the basis of a trigger from the outside thereof such as the buffer 104.

The controller 101 is configured to select a plurality of terminals to which a DL-MU transmission is to be performed, from among the terminals with which wireless links have been established. The controller 101 performs the DL-MU transmission by using mutually-different communication resources for the plurality of selected terminals. For example, an aggregated frame containing a plurality of data frames is generated for each of the terminals, so as to transmit the aggregated frames simultaneously (by a DL-MU transmission). Padding data may be added to the tail end of any of the aggregated frames so as to arrange the lengths thereof to be equal to one another.

The controller 101 is configured to divide the frames (the aggregated frames or the like) to be transmitted to the plurality of selected terminals into a plurality of groups and to perform control so that acknowledgement response frames are transmitted by UL-MU in such a manner that the transmissions thereof do not temporally overlap one another among the groups. In one example, the UL-MU transmission timing of the acknowledgement response frames do not overlap among the groups, by staggering the timing for the transmissions of the trigger frames among the groups. Alternatively, it is also acceptable to arrange the acknowledgement response frames to be transmitted by UL-MU with transmission timing varied among the groups, by simultaneously transmitting (by a DL-MU transmission) trigger frames designating the transmission timing varied among the groups. It is also acceptable to transmit, by a DL-MU transmission, aggregated frames each containing the frames to be transmitted to a corresponding one of the terminals and a trigger frame for the terminal. It is also acceptable to transmit, by a DL-MU transmission, aggregated frames to the terminals and a single trigger frame. It is also acceptable to transmit, by a single user transmission, a single trigger frame by using a band having the channel width. It is also possible to control the transmission timing of the acknowledgement response frames by using a method (e.g., by using BAR frames) other than the methods described above (See the first to the fifth sequence examples explained above). In the trigger frame, in an example, parameter information necessary to enable the terminal to perform an uplink transmission is set. For instance, examples of the set information include the identifier of the terminal to perform an uplink transmission, information on a communication resource or the like to be used in the uplink transmission, information on the timing with which the uplink transmission is to be performed.

At the time when having acquired an access right to a wireless medium according to CSMA/CA or at a time determined in advance, the controller 101 outputs, to the transmitter 102, a single frame when performing a single user transmission and a plurality of frames (which may be aggregated frames) for the plurality of terminals when performing a DL-MU transmission. The transmitter 102 generates a physical packet by performing desirable physical layer processes (which include a process in accordance with the DL-OFDMA, the DL-MU-MIMO, or the DL-OFDMA-MIMO scheme) such as an encoding process, a modulation process, and a physical header addition process, on the frames input thereto. Further, the transmitter 102 performs a DA conversion, a filter process to extract a desired band component, a frequency conversion (an up-conversion process) to a wireless frequency, or the like, on the physical packet. The transmitter 102 amplifies the signals having a wireless frequency obtained in this manner by using a pre-amplifier and transmits the signals into the air as a radio wave, via one or more of the antennas.

The signals received by the antennas are processed by the receiver 103. For example, signals of the frames (which may be aggregated frames) returned from the plurality of terminals by a UL-MU communication are simultaneously received by the antennas. The received signal is amplified by a Low Noise Amplifier (LNA), and the frequency thereof is converted (through a down-conversion process) to a baseband, before a desired band component is extracted by a filter process. The extracted signal is further converted into a digital signal by an AD conversion, and physical layer processes such as a demodulation process, an error-correction decode process, and a physical header process are performed thereon, before the frames from the plurality of terminals are input to the controller 101. The physical layer processes may include the spatial separation of the frames for each of the terminals when UL-MU-MIMO is used, may include the frame extraction for each of the resource units when UL-OFDMA is used, and may include both of these processes when UL-OFDMA & MU-MIMO is used. When OFDMA is used, a reception system may be provided for each of the antennas, so that the corresponding frequency bands are mutually different. In that situation, reception systems may be provided in units of resource units. Alternatively, it is also acceptable to arrange the reception systems to correspond to mutually-the-same frequency band, so that the signals received by the reception systems are combined together by using a diversity technique. In that situation, the signals of the resource units may be extracted by performing a digital filter process.

The controller 101 may access a storage for storing the information to be transmitted via the trigger frame etc. to the terminals or the information received from the terminal, or the both of these to read out the information. The storage may be a buffer included in the controller 101 (internal memory) or a buffer provided outside the controller 101 (external memory). The storage may be a volatile memory or a non-volatile memory. The storage may also be an SSD, a hard disk or the like other than the memory.

The above described isolation of the processes of the controller 101 and transmitter 102 is an example, and another form may be used. For example, the controller 101 may perform the process until the digital domain process, and the transmitter 102 may perform the DA conversion and the subsequent processes. As for the isolation of the processes of the controller 101 and receiver 103, similarly, the receiver 103 may perform the process until the AD conversion and the controller 101 may perform the digital domain process including the subsequent process of the physical layer. Isolation other than those described above may be used. As one example, the baseband integrated circuit in accordance with this embodiment corresponds to the controller 101, the section that carries out the processing of the physical layer and the section that carries out the DA conversion in the transmitter 102, and the section that carries out the processing processes including and following the AD conversion in the receiver 103. The RF integrated circuit corresponds to the section that carries out the processing processes including and following the DA conversion in the transmitter 102 and the section that carries out the processing processes prior to the AD conversion in the receiver 103. The integrated circuit for the wireless communication in accordance with this embodiment includes at least a baseband integrated circuit from the baseband integrated circuit and the RF integrated circuit. The processing processes between blocks or processing processes between the baseband integrated circuit and the RF integrated circuit may be demarcated from each other in accordance with any method other than those described herein.

FIG. 22 is a functional block diagram of a wireless communication device installed in any of the terminals. The wireless communication device installed in each of the terminals 1 to 10 illustrated in FIG. 1 has the configuration illustrated in FIG. 22.

The wireless communication device includes a controller 201, a transmitter 202, a receiver 203, and at least one antenna 1, and a buffer 204. The controller 201 corresponds to either a controller or a baseband integrated circuit or controlling circuitry configured to control communication with the access point 11. The transmitter 202 and the receiver 203 correspond to either a wireless communicator or an RF integrated circuit configured to transmit and receive frames. All or a part of the processes performed by the controller 201 and the processes performed by digital domains of the transmitter 202 and the receiver 203 may be realized by software (a program) operated by a processor such as a CPU, may be realized by hardware, or may be realized by both the software and the hardware. Each of the terminals may include a processor that performs all or a part of the processes of the controller 201, the transmitter 202, and the receiver 203.

The buffer 204 is a storage configured to transfer the frames and the like between an upper layer and the controller 201. The buffer 204 may be a volatile memory such as a DRAM or may be a non-volatile memory such as a NAND, a MRAM, or the like. The upper layer is configured to generate a frame to be transmitted to another terminal, the access point 11, or a device (e.g., a server) in another network and to store the generated frame into the buffer 204. The upper layer is also configured to receive either a frame or data received from another terminal, the access point, a device, or the like from the controller 201 via the buffer 204. Further, the upper layer may perform a communication process in a layer upper than the MAC layer, such as a TCP/IP or UDP/IP communication process. Alternatively, a TCP/IP or UDP/IP communication process may be processed by the controller 201, so that the upper layer performs a process in an application layer upper than the TCP/IP or UDP/IP. The operations of the upper layer may be realized as a result of software (a program) being processed by a processor such as a CPU, may be realized by hardware, or may be realized by both software and hardware.

The controller 201 is primarily configured to perform a process on the MAC layer. By transmitting and receiving frames to and from the access point 11 via the transmitter 202 and the receiver 203, the controller 201 is configured to control the communication with the access point 11. Further, the controller 201 may include a clock generator configured to generate a clock, so that the time in the device is managed by using the clock generated by the clock generator. The controller 201 may output the clock generated by the clock generator to the outside thereof. Alternatively, the controller 201 may receive an input of a clock generated by a clock generator provided on the outside thereof so as to manage the time in the device by using the clock.

In an example, the controller 201 is configured to identify attributes and synchronization information of the BBS by receiving a beacon frame from the access point 11 and to subsequently perform an association process by making an association request to the access point 11. In this manner, by exchanging necessary information such as capabilities, attributes, and the like of each other (which may include capability information indicating whether each of the OFDMA, MU-MIMO, OFDMA & MU-MIMO schemes is executable), the controller 201 establishes a wireless link with the access point 11. As necessary, the controller 201 may perform an authentication process with the access point prior to the association process. By periodically checking on the buffer 204, the controller 201 finds out the state of the buffer 204, such as whether there is any data for an uplink transmission or not. Alternatively, the controller 201 may check the state of the buffer 204 on the basis of a trigger from the outside thereof such as the buffer 204. After checking with the buffer 204 whether there is any data to be transmitted to the access point 11, the controller 201 may acquire an access right (a transmission right) to a wireless medium on the basis of CSMA/CA or the like, may subsequently generate a frame such as a data frame, and transmit the generated frame via the transmitter 202 and the antenna 1.

The transmitter 202 generates a physical packet by performing desirable physical layer processes (which include a process in accordance with the OFDMA, the MU-MIMO, or the OFDMA & MU-MIMO scheme) such as an encoding process, a modulation process, and a physical header addition process, on the frames input thereto from the controller 201. Further, the transmitter 202 performs a DA conversion, a filter process to extract a desired band component, a frequency conversion (an up-conversion process) to a wireless frequency, or the like on the physical packet. The transmitter 202 amplifies the signals having a wireless frequency obtained in this manner by using a pre-amplifier and transmits the signals into the air as a radio wave via one or more of the antennas. When a plurality of antennas are provided, it is also possible to control the directivity of the transmission by using the plurality of antennas.

The signal received by the antenna 1 is processed by the receiver 203. The received signal is amplified in the receiver 203 by an LNA, and the frequency thereof is converted (through a down-conversion process) to a baseband, before a desired band component is extracted by a filter process. The extracted signal is further converted into a digital signal by an AD conversion, and physical layer processes such as a demodulation process, an error-correction decode process, and a physical header process are performed thereon, before the frames such as data frames are input to the controller 201. When either DL-OFDMA or DL-OFDMA & MU-MIMO is used, the physical layer processes may include processes of identifying the resource unit to be used by the terminal thereof by referring to the physical header and decoding the signal of the identified resource unit.

When a trigger frame has been received from the access point 11, the controller 201 determines to transmit an acknowledgement response frame with respect to data frames (e.g., the plurality of data frames aggregated in the same frame as the trigger frame) for which an acknowledgement has not yet been made to the access point. Depending on the configuration of the trigger frame, the controller 201 may determine to transmit the acknowledgement response frame, when the terminal thereof is designated in the trigger frame as a terminal subject to UL-MU. The controller 201 may judge whether the terminal thereof is designated or not by, for example, checking whether the identification information of the terminal thereof is set in either a control field or any of the terminal information fields. When a group identifier (which may be a group ID defined by IEEE 802.11ac) of the group to which the terminal thereof belongs is set in either the control field or the common information field, the controller 201 may check whether the terminal thereof is designated in any of the terminal information fields only if the terminal thereof belongs to the group identified by the group identifier. Further, when there is a rule indicating that all of the terminals belonging to the group designated in the common information field are allowed to perform a UL-MU transmission and when the group identifier to which the terminal thereof belongs is configured in the common information field, the controller 201 may judge whether the terminal thereof is designated or not by checking whether the terminal thereof belongs to the group identifier or not.

The controller 201 transmits an acknowledgement response frame when a predetermined time period has elapsed since the receiving of the trigger frame is completed. At that time, when the communication resource to be used in the transmission of the trigger frame is designated in the trigger frame, the controller 201 performs the transmission by using the designated communication resource. When the communication resource to be used is known in advance, the controller 201 uses the communication resource known in advance. The communication resource is a resource unit when UL-OFDMA is used and is a preamble signal when UL-MU-MIMO is used. Both a resource unit and a preamble signal serve as the communication resource when UL-OFDMA & MU-MIMO is used. In addition, when one or more other parameters are designated in the trigger frame, the controller 201 generates and transmits the acknowledgement response frame according to the designated parameters. For example, when the trigger frame contains information instructing the transmission timing of the acknowledgement response frame, the controller 201 transmits the acknowledgement response frame with the instructed timing. The timing may be an adjustment amount for predetermined timing (for example, the adjustment amount may be set for each of the terminals to enable the access point to receive signals from the plurality of terminals simultaneously with a high level of precision). In that situation, the controller 201 transmits the acknowledgement response frame with the timing obtained by changing the predetermined timing by the designated adjustment amount. The acknowledgement response frame may be transmitted alone. Alternatively, the controller 201 may transmit an aggregated frame aggregating the acknowledgement response frame together with one or more frames of other types. Either the acknowledgement response frame or the aggregated frame is transmitted as a physical packet via the transmitter 202 and the antenna 1. The operations performed by the transmitter 202 are as described above.

When having transmitted frames such as data frames to the access point, the controller 201 receives the acknowledgement response frame transmitted from the access point 11. On the basis of the acknowledgement frame, the controller 201 judges whether the frames transmitted by the terminal thereof were successful or not. When an aggregated frame containing a plurality of data frames has been transmitted, the controller 201 judges whether the aggregated plurality of data frames were successful or not. One or more of the data frames that failed in the transmission may be re-transmitted at the next transmission opportunity. For example, when a trigger frame is received next time or when a trigger frame designates the terminal thereof, the controller 201 may transmit an aggregated frame containing the re-transmitted frames, together with an acknowledgement response frame.

The controller 201 may access a storage device that stores either information to be notified to the access point 11 or the information notified from the access point 11 or both of these pieces of information and read the information. The storage device may be an internal memory device, an external memory device, a volatile memory device, or a non-volatile memory. Also, the storage devices such as an SSD and a hard disk may be used in place of the memory device.

The above described isolation of the processes of the controller 201 and transmitter 202 is an example, and another form may be used. For example, the controller 201 may perform the process until the digital domain process, and the transmitter 202 may perform the DA conversion and the subsequent processes. Similarly as for the isolation of the processes of the controller 201 and receiver 203, the receiver 203 may perform the process until the AD conversion and the controller 201 may perform the digital domain process including the subsequent process of the physical layer. Isolation other than those described above may be used. As one example, the baseband integrated circuit in accordance with this embodiment corresponds to the controller 201, the section that carries out the processing of the physical layer and the section that carries out the DA conversion in the transmitter 202, and the section that carries out the processing processes including and following the AD conversion in the receiver 203. The RF integrated circuit corresponds to the section that carries out the processing processes including and following the DA conversion in the transmitter 202 and the section that carries out the processing processes prior to the AD conversion in the receiver 203. The integrated circuit for the wireless communication in accordance with this embodiment includes at least a baseband integrated circuit from the baseband integrated circuit and the RF integrated circuit. The processing processes between blocks or processing processes between the baseband integrated circuit and the RF integrated circuit may be demarcated from each other in accordance with any method other than those described

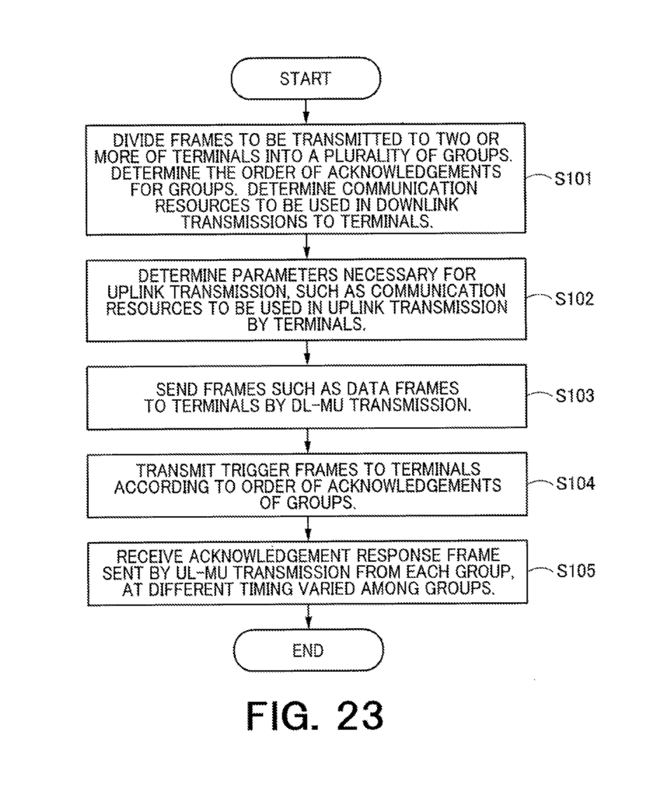

FIG. 23 is a flowchart illustrating operations performed by the access point according to the first embodiment. The controller 101 included in the access point selects a plurality of terminals (or a plurality of wireless communication devices) to which a DL-MU transmission is to be performed and divides the frames to be transmitted to the plurality of selected terminals into a plurality of groups (S101). The controller 101 then determines the order in which each of the groups is caused to transmit an acknowledgement response frame (by a UL-MU transmission) (S101). Further, the controller 101 determines the communication resource to be used in the DL-MU transmission for the plurality of selected terminals.

Further, the controller 101 determines parameter information necessary for the uplink transmissions performed by the plurality of selected terminals (S102). For example, the controller 101 determines the communication resources to be used by the terminals in the uplink transmissions. As necessary, the controller 101 may additionally determine one or more other parameters (e.g., an MCS or a packet length) to be used in the uplink transmissions.

The controller 101 transmits, by DL-MU, the frames (which may be an aggregated frame) such as data frames to be transmitted to the plurality of selected terminals, to the plurality of selected terminals, by using the communication resources determined above (S103).

Further, the controller 101 generates a trigger frame for each of the plurality of selected terminals and transmits the generated trigger frames (S104). The trigger frame may contain the identifier of the terminal and parameter information (e.g., information designating the transmission timing of the acknowledgement frame or the communication resource) necessary for the uplink transmission. As for the transmissions of the trigger frames, the trigger frames for at least the terminals belonging to mutually-the-same group may be transmitted simultaneously (by a DL-MU transmission). The trigger frames for all the groups may be transmitted simultaneously (by a DL-MU transmission). Alternatively, the DL-MU transmissions of the trigger frames may be arranged not to overlap among the groups. It is also acceptable to generate a plurality of aggregated frames each aggregating together a trigger frame and the abovementioned frames to be transmitted to a corresponding one of the terminals and to transmit the generated aggregated frames. Further, instead of generating a trigger frame for each of the terminals, it is also acceptable to generate a single trigger frame for all of the selected terminals, so as to transmit (by a DL-MU transmission) the generated trigger frame at the same time with the data frames and the like that are transmitted to the plurality of terminals at step S103. Alternatively, it is also acceptable to transmit the single trigger frame by a single user transmission while using a band having the channel width.

The access point receives, for each of the groups, the acknowledgement frames transmitted from the plurality of terminals by the UL-MU transmission (S105). Because the control is performed so that the time periods of the UL-MU transmissions do not overlap one another among the groups, it is possible to properly receive the plurality of acknowledgement frames transmitted from the groups by the UL-MU transmission.

FIG. 24 is a flowchart illustrating operations performed by one of the terminals according to the first embodiment. The controller 201 included in the terminal receives a frame (which may be an aggregated frame) such as a data frame transmitted by DL-MU from the access point and judges whether the reception was successful or not, i.e., whether the frame was properly received or not (S201). Further, the controller 201 included in the terminal receives the trigger frame transmitted thereto from the access point (S202) and identifies parameters necessary for the transmission of an acknowledgement response frame, e.g., a communication resource to be used for the transmission. The controller 201 transmits the acknowledgement response frame by using the communication resource, when a predetermined time period has elapsed since the receiving of the trigger frame is completed (S203). When the trigger frame designates information related to the transmission timing of the acknowledgement response frame, the controller 201 transmits the acknowledgement response frame with the timing designated in the information.

As explained above, according to the present embodiment, the plurality of frames to be transmitted to the plurality of terminals are divided into the plurality of groups, and the control is performed sequentially on the plurality of groups so that the acknowledgement response frames are transmitted from the terminals corresponding to each of the groups by the UL-MU at timings not overlap among the groups. Accordingly, the access point is able to efficiently receive the acknowledgement response frames from the plurality of terminals. For example, when the multiplexing number of the frames to be transmitted to the plurality of terminals is larger than the maximum multiplexing number of the UL-MU transmission used for transmitting the acknowledgement response frames, it is possible to receive the acknowledgement response frames at a high rate.

### Second Embodiment

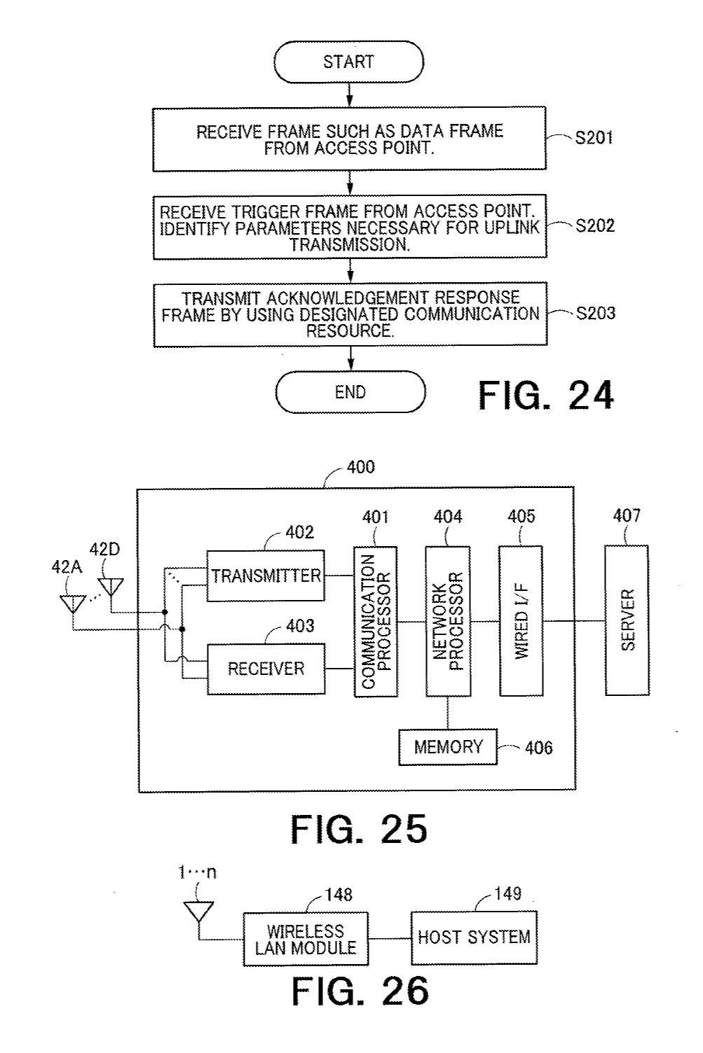

FIG. 25 is a functional block diagram of a base station (access point) 400 according to a second embodiment. The access point includes a communication processor 401, a transmitter 402, a receiver 403, antennas 42A, 42B, 42C, and 42D, a network processor 404, a wired I/F 405, and a memory 406. The access point 400 is connected to a server 407 through the wired I/F 405. The communication processor 401 has functions similar to the MAC processor 10 and the MAC/PHY manager 60 described in the first embodiment. The transmitter 402 and the receiver 403 have functions similar to the PHY processor 50 and the analog processor 70 described in the first embodiment. The network processor 404 has functions similar to the higher processor 90 described in the first embodiment. The communication processor 401 may internally possess a buffer for transferring data to and from the network processor 404. The buffer may be a volatile memory, such as an SRAM or a DRAM, or may be a non-volatile memory, such as a NAND or an MRAM.

The network processor 404 controls data exchange with the communication processor 401, data writing and reading to and from the memory 406, and communication with the server 407 through the wired I/F 405. The network processor 404 may execute a higher communication process of the MAC layer, such as TCP/IP or UDP/IP, or a process of the application layer. The operation of the network processor may be performed through processing of software (program) by a processor, such as a CPU. The operation may be performed by hardware or may be performed by both of the software and the hardware.

For example, the communication processor 401 corresponds to a baseband integrated circuit, and the transmitter 402 and the receiver 403 correspond to an RF integrated circuit that transmits and receives frames. The communication processor 401 and the network processor 404 may be formed by one integrated circuit (one chip). Parts that execute processing of digital areas of the transmitter 402 and the receiver 403 and parts that execute processing of analog areas may be formed by different chips. The communication processor 401 may execute a higher communication process of the MAC layer, such as TCP/IP or UDP/IP. Although the number of antennas is four here, it is only necessary that at least one antenna is included.

The memory 406 saves data received from the server 407 and data received by the receiver 402. The memory 406 may be, for example, a volatile memory, such as a DRAM, or may be a non-volatile memory, such as a NAND or an MRAM. The memory 406 may be an SSD, an HDD, an SD card, an eMMC, or the like. The memory 406 may be provided outside of the base station 400.

The wired I/F 405 transmits and receives data to and from the server 407. Although the communication with the server 407 is performed through a wire in the present embodiment, the communication with the server 407 may be performed wirelessly. In this case, a wireless I/F may be employed instead of the wired I/F 405.

The server 407 is a communication device that returns a response including requested data in response to reception of a data forward request for requesting transmission of the data. Examples of the server 407 include an HTTP server (Web server) and an FTP server. However, the server 407 is not limited to these as long as the server 407 has a function of returning the requested data. The server 407 may be a communication device operated by the user, such as a PC or a smartphone.

When the STA belonging to the BSS of the base station 400 issues a forward request of data for the server 407, a packet regarding the data forward request is transmitted to the base station 400. The base station 400 receives the packet through the antennas 42A to 42D. The base station 400 causes the receiver 403 to execute the process of the physical layer and the like and causes the communication processor 401 to execute the process of the MAC layer and the like.

The network processor 404 analyzes the packet received from the communication processor 401. Specifically, the network processor 404 checks the destination IP address, the destination port number, and the like. When the data of the packet is a data forward request such as an HTTP GET request, the network processor 404 checks whether the data requested by the data forward request (for example, data in the URL requested by the HTTP GET request) is cached (stored) in the memory 406. A table associating the URL (or reduced expression of the URL, such as a hash value or an identifier substituting the URL) and the data is stored in the memory 406. The fact that the data is cached in the memory 406 will be expressed that the cache data exists in the memory 406.

When the cache data does not exist in the memory 406, the network processor 404 transmits the data forward request to the server 407 through the wired I/F 405. In other words, the network processor 404 substitutes the STA to transmit the data forward request to the server 407. Specifically, the network processor 404 generates an HTTP request and executes protocol processing, such as adding the TCP/IP header, to transfer the packet to the wired I/F 405. The wired I/F 405 transmits the received packet to the server 407.

The wired I/F 405 receives, from the server 407, a packet that is a response to the data forward request. From the IP header of the packet received through the wired I/F 405, the network processor 404 figures out that the packet is addressed to the STA and transfers the packet to the communication processor 401. The communication processor 401 executes processing of the MAC layer and the like for the packet. The transmitter 402 executes processing of the physical layer and the like and transmits the packet addressed to the STA from the antennas 42A to 42D. The network processor 404 associates the data received from the server 407 with the URL (or reduced expression of the URL) and saves the cache data in the memory 406.

When the cache data exists in the memory 406, the network processor 404 reads the data requested by the data forward request from the memory 406 and transmits the data to the communication processor 401. Specifically, the network processor 404 adds the HTTP header or the like to the data read from the memory 406 and executes protocol processing, such as adding the TCP/IP header, to transmit the packet to the communication processor 401. In this case, the transmitter IP address of the packet is set to the same IP address as the server, and the transmitter port number is also set to the same port number as the server (destination port number of the packet transmitted by the communication terminal), for example. Therefore, it can be viewed from the STA as if communication with the server 407 is established. The communication processor 401 executes processing of the MAC layer and the like for the packet. The transmitter 402 executes processing of the physical layer and the like and transmits the packet addressed to the STA from the antennas 42A to 42D.

According to the operation, frequently accessed data is responded based on the cache data saved in the memory 406, and the traffic between the server 407 and the base station 400 can be reduced. Note that the operation of the network processor 404 is not limited to the operation of the present embodiment. There is no problem in performing other operation when a general caching proxy is used, in which data is acquired from the server 407 in place of the STA, the data is cached in the memory 406, and a response is made from the cache data of the memory 406 for a data forward request of the same data.

The base station (access point) of the present embodiment can be applied as the base station of the first embodiment. In this case, the transmission of the frame, the data or the packet used in the first embodiment may be carried out based on the cached data stored in the memory 406.

In the present embodiment, although the base station with the cache function is described, a terminal (STA) with the cache function can also be realized by the same block configuration as FIG. 25. In this case, the wired I/F 405 may be omitted.

### Third Embodiment

FIG. 26 shows an example of entire configuration of a terminal or a base station. The example of configuration is just an example, and the present embodiment is not limited to this. The terminal or the base station includes one or a plurality of antennas 1 to n (n is an integer equal to or greater than 1), a wireless LAN module 148, and a host system 149. The wireless LAN module 148 corresponds to the wireless communication device according to the first embodiment. The wireless LAN module 148 includes a host interface and is connected to the host system 149 through the host interface. Other than the connection to the host system 149 through the connection cable, the wireless LAN module 148 may be directly connected to the host system 149. The wireless LAN module 148 can be mounted on a substrate by soldering or the like and can be connected to the host system 149 through wiring of the substrate. The host system 149 uses the wireless LAN module 148 and the antennas 1 to n to communicate with external apparatuses according to an arbitrary communication protocol. The communication protocol may include the TCP/IP and a protocol of a layer higher than that. Alternatively, the TCP/IP may be mounted on the wireless LAN module 148, and the host system 149 may execute only a protocol in a layer higher than that. In this case, the configuration of the host system 149 can be simplified. Examples of the present terminal include a mobile terminal, a TV, a digital camera, a wearable device, a tablet, a smartphone, a game device, a network storage device, a monitor, a digital audio player, a Web camera, a video camera, a projector, a navigation system, an external adaptor, an internal adaptor, a set top box, a gateway, a printer server, a mobile access point, a router, an enterprise/service provider access point, a portable device, a hand-held device, a vehicle and so on.

The wireless LAN module 148 (or the wireless communication device) may have functions of other wireless communication standards such as LTE (Long Term Evolution), LTE-Advanced (standards for mobile phones) as well as the IEEE802.11.

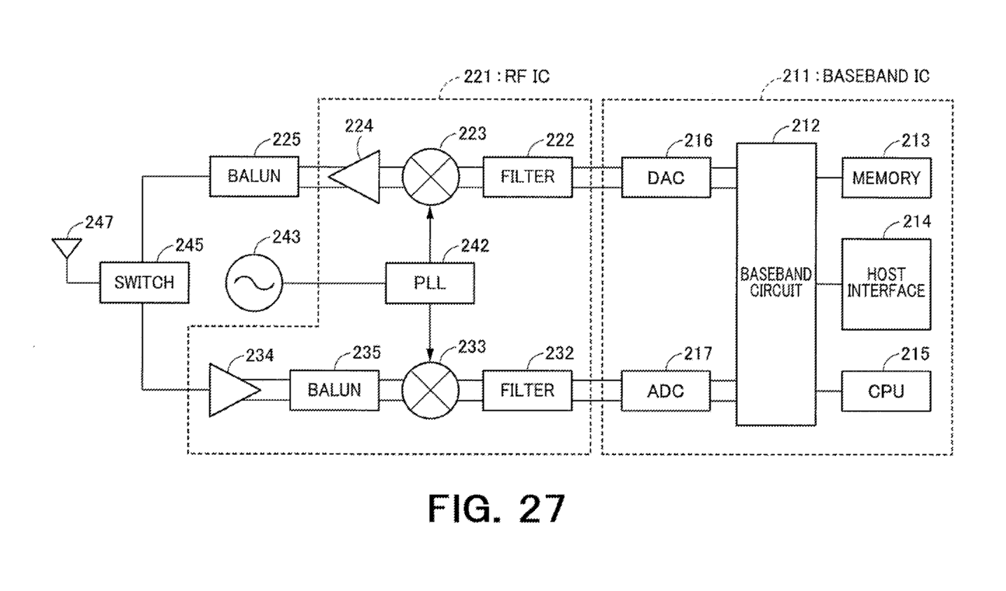

FIG. 27 shows an example of hardware configuration of a wireless LAN module. The configuration can also be applied when the wireless communication device is mounted on either one of the terminal that is a non-base station and the base station. Therefore, the configuration can be applied as an example of specific configuration of the wireless communication device shown in FIG. 21 or FIG. 22. At least one antenna 247 is included in the example of configuration. When a plurality of antennas are included, a plurality of sets of a transmission system (216 and 222 to 225), a reception system (217, 232 to 235), a PLL 242, a crystal oscillator (reference signal source) 243, and a switch 245 may be arranged according to the antennas, and each set may be connected to a control circuit 212. One or both of the PLL 242 and the crystal oscillator 243 correspond to an oscillator according to the present embodiment.

The wireless LAN module (wireless communication device) includes a baseband IC (Integrated Circuit) 211, an RF (Radio Frequency) IC 221, a balun 225, the switch 245, and the antenna 247.

The baseband IC 211 includes the baseband circuit (control circuit) 212, a memory 213, a host interface 214, a CPU 215, a DAC (Digital to Analog Converter) 216, and an ADC (Analog to Digital Converter) 217.

The baseband IC 211 and the RF IC 221 may be formed on the same substrate. The baseband IC 211 and the RF IC 221 may be formed by one chip. Both or one of the DAC 216 and the ADC 217 may be arranged on the RF IC 221 or may be arranged on another IC. Both or one of the memory 213 and the CPU 215 may be arranged on an IC other than the baseband IC.

The memory 213 stores data to be transferred to and from the host system. The memory 213 also stores one or both of information to be transmitted to the terminal or the base station and information transmitted from the terminal or the base station. The memory 213 may also store a program necessary for the execution of the CPU 215 and may be used as a work area for the CPU 215 to execute the program. The memory 213 may be a volatile memory, such as an SRAM or a DRAM, or may be a non-volatile memory, such as a NAND or an MRAM.

The host interface 214 is an interface for connection to the host system. The interface can be anything, such as UART, SPI, SDIO, USB, or PCI Express.

The CPU 215 is a processor that executes a program to control the baseband circuit 212. The baseband circuit 212 mainly executes a process of the MAC layer and a process of the physical layer. One or both of the baseband circuit 212 and the CPU 215 correspond to the communication control apparatus that controls communication, the controller that controls communication, or controlling circuitry that controls communication.

At least one of the baseband circuit 212 or the CPU 215 may include a clock generator that generates a clock and may manage internal time by the clock generated by the clock generator.

For the process of the physical layer, the baseband circuit 212 performs addition of the physical header, coding, encryption, modulation process, and the like of the frame to be transmitted and generates, for example, two types of digital baseband signals (hereinafter, “digital I signal” and “digital Q signal”).

The DAC 216 performs DA conversion of signals input from the baseband circuit 212. More specifically, the DAC 216 converts the digital I signal to an analog I signal and converts the digital Q signal to an analog Q signal. Note that a single system signal may be transmitted without performing quadrature modulation. When a plurality of antennas are included, and single system or multi-system transmission signals equivalent to the number of antennas are to be distributed and transmitted, the number of provided DACs and the like may correspond to the number of antennas.

The RF IC 221 is, for example, one or both of an RF analog IC and a high frequency IC. The RF IC 221 includes a filter 222, a mixer 223, a preamplifier (PA) 224, the PLL (Phase Locked Loop) 242, a low noise amplifier (LNA) 234, a balun 235, a mixer 233, and a filter 232. Some of the elements may be arranged on the baseband IC 211 or another IC. The filters 222 and 232 may be bandpass filters or low pass filters. The RF IC 221 is connected to the antenna 247 through the switch 245.

The filter 222 extracts a signal of a desired band from each of the analog I signal and the analog Q signal input from the DAC 216. The PLL 242 uses an oscillation signal input from the crystal oscillator 243 and performs one or both of division and multiplication of the oscillation signal to thereby generate a signal at a certain frequency synchronized with the phase of the input signal. Note that the PLL 242 includes a VCO (Voltage Controlled Oscillator) and uses the VCO to perform feedback control based on the oscillation signal input from the crystal oscillator 243 to thereby obtain the signal at the certain frequency. The generated signal at the certain frequency is input to the mixer 223 and the mixer 233. The PLL 242 is equivalent to an example of an oscillator that generates a signal at a certain frequency.

The mixer 223 uses the signal at the certain frequency supplied from the PLL 242 to up-convert the analog I signal and the analog Q signal passed through the filter 222 into a radio frequency. The preamplifier (PA) amplifies the analog I signal and the analog Q signal at the radio frequency generated by the mixer 223, up to desired output power. The balun 225 is a converter for converting a balanced signal (differential signal) to an unbalanced signal (single-ended signal). Although the balanced signal is handled by the RF IC 221, the unbalanced signal is handled from the output of the RF IC 221 to the antenna 247. Therefore, the balun 225 performs the signal conversions.

The switch 245 is connected to the balun 225 on the transmission side during the transmission and is connected to the LNA 234 or the RF IC 221 on the reception side during the reception. The baseband IC 211 or the RF IC 221 may control the switch 245. There may be another circuit that controls the switch 245, and the circuit may control the switch 245.

The analog I signal and the analog Q signal at the radio frequency amplified by the preamplifier 224 are subjected to balanced-unbalanced conversion by the balun 225 and are then emitted as radio waves to the space from the antenna 247.

The antenna 247 may be a chip antenna, may be an antenna formed by wiring on a printed circuit board, or may be an antenna formed by using a linear conductive element.

The LNA 234 in the RF IC 221 amplifies a signal received from the antenna 247 through the switch 245 up to a level that allows demodulation, while maintaining the noise low. The balun 235 performs unbalanced-balanced conversion of the signal amplified by the low noise amplifier (LNA) 234. The mixer 233 uses the signal at the certain frequency input from the PLL 242 to down-convert, to a baseband, the reception signal converted to a balanced signal by the balun 235. More specifically, the mixer 233 includes a unit that generates carrier waves shifted by a phase of 90 degrees based on the signal at the certain frequency input from the PLL 242. The mixer 233 uses the carrier waves shifted by a phase of 90 degrees to perform quadrature demodulation of the reception signal converted by the balun 235 and generates an I (In-phase) signal with the same phase as the reception signal and a Q (Quad-phase) signal with the phase delayed by 90 degrees. The filter 232 extracts signals with desired frequency components from the I signal and the Q signal. Gains of the I signal and the Q signal extracted by the filter 232 are adjusted, and the I signal and the Q signal are output from the RF IC 221.

The ADC 217 in the baseband IC 211 performs AD conversion of the input signal from the RF IC 221. More specifically, the ADC 217 converts the I signal to a digital I signal and converts the Q signal to a digital Q signal. Note that a single system signal may be received without performing quadrature demodulation.

When a plurality of antennas are provided, the number of provided ADCs may correspond to the number of antennas. Based on the digital I signal and the digital Q signal, the baseband circuit 212 executes a process of the physical layer and the like, such as demodulation process, error correcting code process, and process of physical header, and obtains a frame. The baseband circuit 212 applies a process of the MAC layer to the frame. Note that the baseband circuit 212 may be configured to execute a process of TCP/IP when the TCP/IP is implemented.

The baseband circuit 212 or the CPU 215 may execute a process regarding the MIMO. The baseband circuit 212 or the CPU 215 may execute at least one or a plurality of a process of propagation path estimation, a transmission weight calculation process, a separation process of stream, and the like. The baseband circuit 212 or the CPU 215 may control the operation of the filters 222 and 232 to extract signals covered by a used channel according to the setting of the channel. Another controller that controls the filters 222 and 232 may exist, and the baseband circuit 212 or the CPU 215 may issue an instruction to the controller to perform similar control.

The further explanation on processing of the above each block is omitted as being apparent from the explanation of FIG. 21 and FIG. 22

### Fourth Embodiment

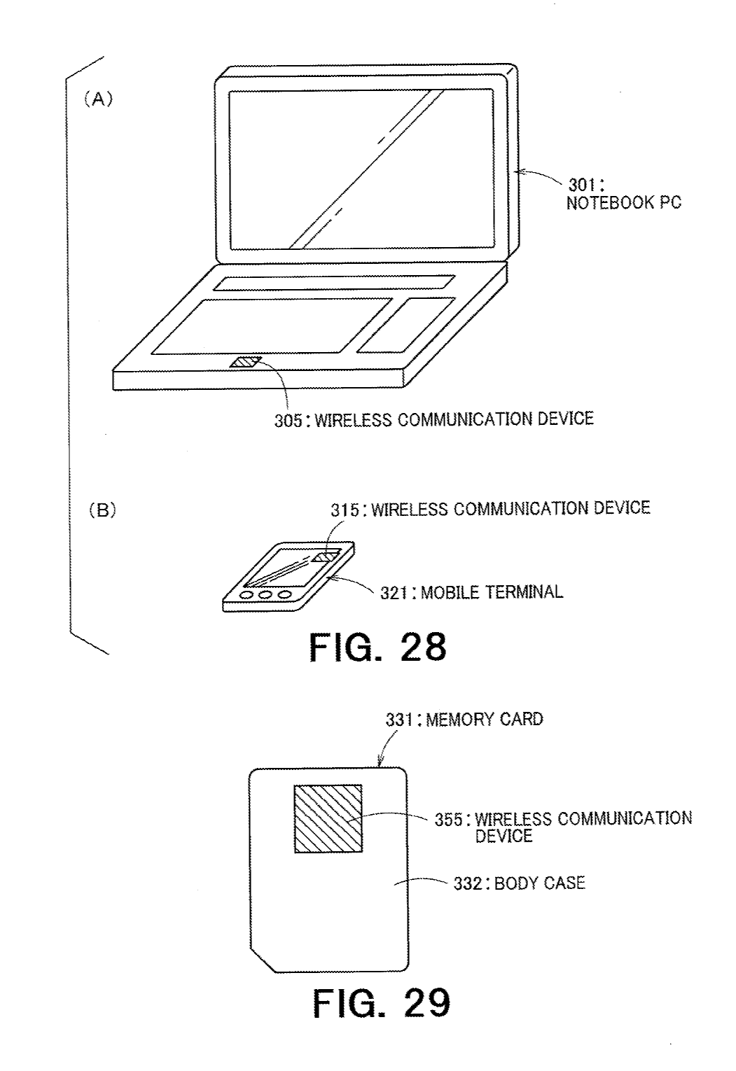

FIG. 28(A) and FIG. 28(B) are perspective views of wireless terminal according to the fourth embodiment. The wireless terminal in FIG. 28(A) is a notebook PC 301 and the wireless communication device (or a wireless device) in FIG. 28(B) is a mobile terminal 321. Each of them corresponds to one form of a terminal (which may indicate a base station). The notebook PC 301 and the mobile terminal 321 are equipped with wireless communication devices 305 and 315, respectively. The wireless communication device provided in a terminal (which may indicate a base station) which has been described above can be used as the wireless communication devices 305 and 315. A wireless terminal carrying a wireless communication device is not limited to notebook PCs and mobile terminals. For example, it can be installed in a TV, a digital camera, a wearable device, a tablet, a smart phone, a gaming device, a network storage device, a monitor, a digital audio player, a web camera, a video camera, a projector, a navigation system, an external adapter, an internal adapter, a set top box, a gateway, a printer server, a mobile access point, a router, an enterprise/service provider access point, a portable device, a handheld device and a vehicle and so on.

Moreover, a wireless communication device installed in a terminal (which may indicate a base station) can also be provided in a memory card. FIG. 29 illustrates an example of a wireless communication device mounted on a memory card. A memory card 331 contains a wireless communication device 355 and a body case 332. The memory card 331 uses the wireless communication device 355 for wireless communication with external devices. Here, in FIG. 29, the description of other installed elements (for example, a memory, and so on) in the memory card 331 is omitted.

### Fifth Embodiment

In the fifth embodiment, a bus, a processor unit and an external interface unit are provided in addition to the configuration of the wireless communication device (which may indicate the wireless communication device mounted in the terminal, the wireless communication device mounted in the base station or both of them) according to any of the above embodiments. The processor unit and the external interface unit are connected with an external memory (a buffer) through the bus. A firmware operates the processor unit. Thus, by adopting a configuration in which the firmware is included in the wireless communication device, the functions of the wireless communication device can be easily changed by rewriting the firmware. The processing unit in which the firmware operates may be a processor that performs the process of the communication controlling device or the control unit according to the present embodiment, or may be another processor that performs a process relating to extending or altering the functions of the process of the communication controlling device or the control unit. The processing unit in which the firmware operates may be included in the access point or the wireless terminal according to the present embodiment. Alternatively, the processing unit may be included in the integrated circuit of the wireless communication device installed in the access point, or in the integrated circuit of the wireless communication device installed in the wireless terminal.

### Sixth Embodiment

In the sixth embodiment, a clock generating unit is provided in addition to the configuration of the wireless communication device (which may indicate the wireless communication device mounted in the terminal, the wireless communication device mounted in the base station or both of them) according to any of the above embodiments. The clock generating unit generates a clock and outputs the clock from an output terminal to the exterior of the wireless communication device. Thus, by outputting to the exterior the clock generated inside the wireless communication device and operating the host by the clock output to the exterior, it is possible to operate the host and the wireless communication device in a synchronized manner.

### Seventh Embodiment

In the seventh embodiment, a power source unit, a power source controlling unit and a wireless power feeding unit are included in addition to the configuration of the wireless communication device (which may indicate the wireless communication device mounted in the terminal, the wireless communication device mounted in the base station or both of them) according to any of the above embodiments. The power supply controlling unit is connected to the power source unit and to the wireless power feeding unit, and performs control to select a power source to be supplied to the wireless communication device. Thus, by adopting a configuration in which the power source is included in the wireless communication device, power consumption reduction operations that control the power source are possible.

### Eighth Embodiment

In the eighth embodiment, a SIM card is added to the configuration of the wireless communication device (which may indicate the wireless communication device mounted in the terminal, the wireless communication device mounted in the base station or both of them) according to the above embodiments. For example, the SIM card is connected with the transmitter (102 or 202), the receiver (103 or 203), the controller (101 or 201), or two or more of them in the wireless communication device. Thus, by adopting a configuration in which the SIM card is included in the wireless communication device, authentication processing can be easily performed.

### Ninth Embodiment

In the ninth embodiment, a video image compressing/decompressing unit is added to the configuration of the wireless communication device (which may indicate the wireless communication device mounted in the terminal, the wireless communication device mounted in the base station or both of them) according to any of the above embodiments. The video image compressing/decompressing unit is connected to the bus. Thus, by adopting a configuration in which the video image compressing/decompressing unit is included in the wireless communication device, transmitting a compressed video image and decompressing a received compressed video image can be easily done.

### Tenth Embodiment

In the tenth embodiment, an LED unit is added to the configuration of the wireless communication device (which may indicate the wireless communication device mounted in the terminal, the wireless communication device mounted in the base station or both of them) according to any of the above embodiments. For example, the LED unit is connected to the transmitter (102 or 202), the receiver (103 or 203), the controller (101 or 201), or two or more of them. Thus, by adopting a configuration in which the LED unit is included in the wireless communication device, notifying the operation state of the wireless communication device to the user can be easily done.

### Eleventh Embodiment

In the eleventh embodiment, a vibrator unit is included in addition to the configuration of the wireless communication device (which may indicate the wireless communication device mounted in the terminal, the wireless communication device mounted in the base station or both of them) according to any of the above embodiments. For example, the vibrator unit is connected to the transmitter (102 or 202), the receiver (103 or 203), the controller (101 or 201), or two or more of them. Thus, by adopting a configuration in which the vibrator unit is included in the wireless communication device, notifying the operation state of the wireless communication device to the user can be easily done.

### Twelfth Embodiment

In a twelfth embodiment, the configuration of the wireless communication device includes a display in addition to the configuration of the wireless communication device (which may indicate the wireless communication device mounted in the terminal, the wireless communication device mounted in the base station or both of them) according to any one of the above embodiments. The display may be connected to the transmitter (102 or 202), the receiver (103 or 203), the controller (101 or 201), or two or more of them. As seen from the above, the configuration including the display to display the operation state of the wireless communication device on the display allows the operation status of the wireless communication device to be easily notified to a user.

### Thirteenth Embodiment

In the present embodiment, [1] the frame type in the wireless communication system, [2] a technique of disconnection between wireless communication devices, [3] an access scheme of a wireless LAN system and [4] a frame interval of a wireless LAN are described.

### [1] Frame Type in Communication System

Generally, as mentioned above, frames treated on a wireless access protocol in a wireless communication system are roughly divided into three types of the data frame, the management frame and the control frame. These types are normally shown in a header part which is commonly provided to frames. As a display method of the frame type, three types may be distinguished in one field or may be distinguished by a combination of two fields. In the IEEE 802.11 standard, identification of a frame type is made based on two fields of Type and Subtype in the Frame Control field in the header part of the MAC frame. The Type field is one for generally classifying frames into a data frame, a management frame, or a control frame and the Subtype field is one for identifying more detailed type in each of the classified frame types such as a beacon frame belonging to the management frame.

The management frame is a frame used to manage a physical communication link with a different wireless communication device. For example, there are a frame used to perform communication setting with the different wireless communication device or a frame to release communication link (that is, to disconnect the connection), and a frame related to the power save operation in the wireless communication device.

The data frame is a frame to transmit data generated in the wireless communication device to the different wireless communication device after a physical communication link with the different wireless communication device is established. The data is generated in a higher layer of the present embodiment and generated by, for example, a user's operation.

The control frame is a frame used to perform control at the time of transmission and reception (exchange) of the data frame with the different wireless communication device. A response frame transmitted for the acknowledgment in a case where the wireless communication device receives the data frame or the management frame, belongs to the control frame. The response frame is, for example, an ACK frame or a BlockACK frame. The RTS frame and the CTS frame are also the control frame.

These three types of frames are subjected to processing based on the necessity in the physical layer and then transmitted as physical packets via an antenna. In IEEE 802.11 standard (including the extended standard such as IEEE Std 802.11ac-2013), an association process is defined as one procedure for connection establishment. The association request frame and the association response frame which are used in the procedure are a management frame. Since the association request frame and the association response frame is the management frame transmitted in a unicast scheme, the frames causes the wireless communication terminal in the receiving side to transmit an ACK frame being a response frame. The ACK frame is a control frame as described in the above.

### [2] Technique of Disconnection Between Wireless Communication Devices

For disconnection, there are an explicit technique and an implicit technique. As the explicit technique, a frame to disconnect any one of the connected wireless communication devices is transmitted. This frame corresponds to Deauthentication frame defined in IEEE 802.11 standard and is classified into the management frame. The frame for disconnection may be referred to as “release frame” by the meaning of releasing connection, for example. Normally, it is determined that the connection is disconnected at the timing of transmitting the release frame in a wireless communication device on the side to transmit the release frame and at the timing of receiving the release frame in a wireless communication device on the side to receive the release frame. Afterward, it returns to the initial state in a communication phase, for example, a state to search for a wireless communication device of the communicating partner. In a case that the wireless communication base station disconnects with a wireless communication terminal, for example, the base station deletes information on the wireless communication device from a connection management table if the base station holds the connection management table for managing wireless communication terminals which entries into the BSS of the base station-self. For example, in a case that the base station assigns an AID to each wireless communication terminal which entries into the BSS at the time when the base station permitted each wireless communication terminal to connect to the base station-self in the association process, the base station deletes the held information related to the AID of the wireless communication terminal disconnected with the base station and may release the AID to assign it to another wireless communication device which newly entries into the BSS.

On the other hand, as the implicit technique, it is determined that the connection state is disconnected in a case where frame transmission (transmission of a data frame and management frame or transmission of a response frame with respect to a frame transmitted by the subject device) is not detected from a wireless communication device of the connection partner which has established the connection for a certain period. Such a technique is provided because, in a state where it is determined that the connection is disconnected as mentioned above, a state is considered where the physical wireless link cannot be secured, for example, the communication distance to the wireless communication device of the connection destination is separated and the radio signals cannot be received or decoded. That is, it is because the reception of the release frame cannot be expected.

As a specific example to determine the disconnection of connection in an implicit method, a timer is used. For example, at the time of transmitting a data frame that requests an acknowledgment response frame, a first timer (for example, a retransmission timer for a data frame) that limits the retransmission period of the frame is activated, and, if the acknowledgement response frame to the frame is not received until the expiration of the first timer (that is, until a desired retransmission period passes), retransmission is performed. When the acknowledgment response frame to the frame is received, the first timer is stopped.

On the other hand, when the acknowledgment response frame is not received and the first timer expires, for example, a management frame to confirm whether a wireless communication device of a connection partner is still present (in a communication range) (in other words, whether a wireless link is secured) is transmitted, and, at the same time, a second timer (for example, a retransmission timer for the management frame) to limit the retransmission period of the frame is activated. Similarly to the first timer, even in the second timer, retransmission is performed if an acknowledgment response frame to the frame is not received until the second timer expires, and it is determined that the connection is disconnected when the second timer expires.

Alternatively, a third timer is activated when a frame is received from a wireless communication device of the connection partner, the third timer is stopped every time the frame is newly received from the wireless communication device of the connection partner, and it is activated from the initial value again. When the third timer expires, similarly to the above, a management frame to confirm whether the wireless communication device of the connection party is still present (in a communication range) (in other words, whether a wireless link is secured) is transmitted, and, at the same time, a second timer (for example, a retransmission timer for the management frame) to limit the retransmission period of the frame is activated. Even in this case, retransmission is performed if an acknowledgment response frame to the frame is not received until the second timer expires, and it is determined that the connection is disconnected when the second timer expires. The latter management frame to confirm whether the wireless communication device of the connection partner is still present may differ from the management frame in the former case. Moreover, regarding the timer to limit the retransmission of the management frame in the latter case, although the same one as that in the former case is used as the second timer, a different timer may be used.

### [3] Access Scheme of Wireless LAN System

For example, there is a wireless LAN system with an assumption of communication or competition with a plurality of wireless communication devices. CSMA/CA is set as the basis of an access scheme in the IEEE802.11 (including an extension standard or the like) wireless LAN. In a scheme in which transmission by a certain wireless communication device is grasped and transmission is performed after a fixed time from the transmission end, simultaneous transmission is performed in the plurality of wireless communication devices that grasp the transmission by the wireless communication device, and, as a result, radio signals collide and frame transmission fails. By grasping the transmission by the certain wireless communication device and waiting for a random time from the transmission end, transmission by the plurality of wireless communication devices that grasp the transmission by the wireless communication device stochastically disperses. Therefore, if the number of wireless communication devices in which the earliest time in a random time is subtracted is one, frame transmission by the wireless communication device succeeds and it is possible to prevent frame collision. Since the acquisition of the transmission right based on the random value becomes impartial between the plurality of wireless communication devices, it can be said that a scheme adopting Carrier Avoidance is a suitable scheme to share a radio medium between the plurality of wireless communication devices.

### [4] Frame Interval of Wireless LAN

The frame interval of the IEEE802.11 wireless LAN is described. There are several types of frame intervals used in the IEEE802.11 wireless LAN, such as distributed coordination function interframe space (DIFS), arbitration interframe space (AIFS), point coordination function interframe space (PIFS), short interframe space (SIFS), extended interframe space (EIFS) and reduced interframe space (RIFS).

The definition of the frame interval is defined as a continuous period that should confirm and open the carrier sensing idle before transmission in the IEEE802.11 wireless LAN, and a strict period from a previous frame is not discussed. Therefore, the definition is followed in the explanation of the IEEE802.11 wireless LAN system. In the IEEE802.11 wireless LAN, a waiting time at the time of random access based on CSMA/CA is assumed to be the sum of a fixed time and a random time, and it can say that such a definition is made to clarify the fixed time.

DIFS and AIFS are frame intervals used when trying the frame exchange start in a contention period that competes with other wireless communication devices on the basis of CSMA/CA. DIFS is used in a case where priority according to the traffic type is not distinguished, AIFS is used in a case where priority by traffic identifier (TID) is provided.

Since operation is similar between DIFS and AIFS, an explanation below will mainly use AIFS. In the IEEE802.11 wireless LAN, access control including the start of frame exchange in the MAC layer is performed. In addition, in a case where QoS (Quality of Service) is supported when data is transferred from a higher layer, the traffic type is notified together with the data, and the data is classified for the priority at the time of access on the basis of the traffic type. The class at the time of this access is referred to as “access category (AC)”. Therefore, the value of AIFS is provided every access category.

PIFS denotes a frame interval to enable access which is more preferential than other competing wireless communication devices, and the period is shorter than the values of DIFS and AIFS. SIFS denotes a frame interval which can be used in a case where frame exchange continues in a burst manner at the time of transmission of a control frame of a response system or after the access right is acquired once. EIFS denotes a frame interval caused when frame reception fails (when the received frame is determined to be error).

RIFS denotes a frame interval which can be used in a case where a plurality of frames are consecutively transmitted to the same wireless communication device in a burst manner after the access right is acquired once, and a response frame from a wireless communication device of the transmission partner is not requested while RIFS is used.

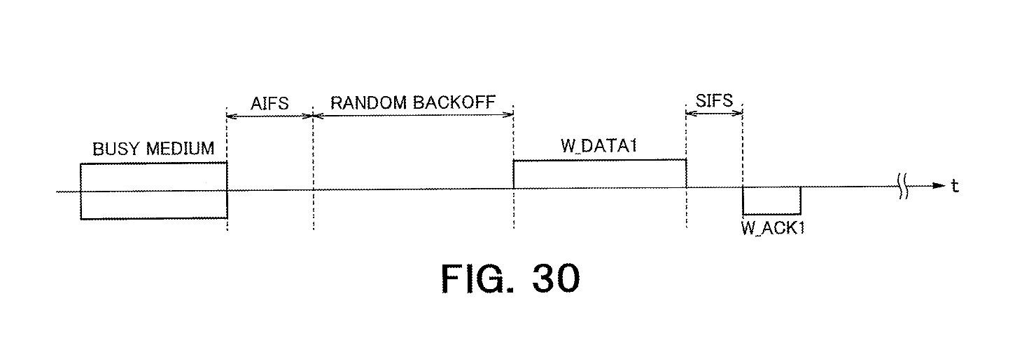

Here, FIG. 30 illustrates one example of frame exchange in a competitive period based on the random access in the IEEE802.11 wireless LAN.

When a transmission request of a data frame (W_DATA1) is generated in a certain wireless communication device, a case is assumed where it is recognized that a medium is busy (busy medium) as a result of carrier sensing. In this case, AIFS of a fixed time is set from the time point at which the carrier sensing becomes idle, and, when a random time (random backoff) is set afterward, data frame W_DATA1 is transmitted to the communicating partner.

The random time is acquired by multiplying a slot time by a pseudorandom integer led from uniform distribution between contention windows (CW) given by integers from 0. Here, what multiplies CW by the slot time is referred to as “CW time width”. The initial value of CW is given by CWmin, and the value of CW is increased up to CWmax every retransmission. Similarly to AIFS, both CWmin and CWmax have values every access category. In a wireless communication device of transmission destination of W_DATA1, when reception of the data frame succeeds, a response frame (W_ACK1) is transmitted after SIFS from the reception end time point. If it is within a transmission burst time limit when W_ACK1 is received, the wireless communication device that transmits W_DATA1 can transmit the next frame (for example, W_DATA2) after SIFS.

Although AIFS, DIFS, PIFS and EIFS are functions between SIFS and the slot-time, SIFS and the slot time are defined every physical layer. Moreover, although parameters whose values being set according to each access category, such as AIFS, CWmin and CWmax, can be set independently by a communication group (which is a basic service set (BSS) in the IEEE802.11 wireless LAN), the default values are defined.

For example, in the definition of 802.11ac, with an assumption that SIFS is 16 μs and the slot time is 9 μs, and thereby PIFS is 25 μs, DIFS is 34 μs, the default value of the frame interval of an access category of BACKGROUND (AC_BK) in AIFS is 79 μs, the default value of the frame interval of BEST EFFORT (AC_BE) is 43 μs, the default value of the frame interval between VIDEO(AC_VI) and VOICE(AC_VO) is 34 μs, and the default values of CWmin and CWmax are 31 and 1023 in AC_BK and AC_BE, 15 and 31 in AC_VI and 7 and 15 in AC_VO. Here, EIFS denotes the sum of SIFS, DIFS, and the time length of a response frame transmitted at the lowest mandatory physical rate. In the wireless communication device which can effectively takes EIFS, it may estimate an occupation time length of a PHY packet conveying a response frame directed to a PHY packet due to which the EIFS is caused and calculates a sum of SIFS, DIFS and the estimated time to take the EIFS.

Note that the frames described in the embodiments may indicate not only things called frames in, for example, the IEEE 802.11 standard, but also things called packets, such as Null Data Packets.

The terms used in each embodiment should be interpreted broadly. For example, the term “processor” may encompass a general purpose processor, a central processing unit (CPU), a microprocessor, a digital signal processor (DSP), a controller, a microcontroller, a state machine, and so on. According to circumstances, a “processor” may refer to an application specific integrated circuit (ASIC), a field programmable gate array (FPGA), and a programmable logic device (PLD), etc. The term “processor” may refer to a combination of processing devices such as a plurality of microprocessors, a combination of a DSP and a microprocessor, or one or more microprocessors in conjunction with a DSP core.

As another example, the term “memory” may encompass any electronic component which can store electronic information. The “memory” may refer to various types of media such as a random access memory (RAM), a read-only memory (ROM), a programmable read-only memory (PROM), an erasable programmable read only memory (EPROM), an electrically erasable PROM (EEPROM), a non-volatile random access memory (NVRAM), a flash memory, and a magnetic or optical data storage, which are readable by a processor. It can be said that the memory electronically communicates with a processor if the processor read and/or write information for the memory. The memory may be arranged within a processor and also in this case, it can be said that the memory electronically communication with the processor. The term “circuitry” may refer to not only electric circuits or a system of circuits used in a device but also a single electric circuit or a part of the single electric circuit. Moreover, the term “circuitry” may refer one or more electric circuits disposed on a single chip, or may refer one or more electric circuits disposed on a plurality of chips more than one chip or a plurality of devices in a dispersed manner.

In the specification, the expression “at least one of a, b or c” is an expression to encompass not only “a”, “b”, “c”, “a and b”, “a and c”, “b and c”, “a, b and c” or any combination thereof but also a combination of at least a plurality of same elements such as “a and a”, “a, b and b” or “a, a, b, b, c and c”. Also, the expression is an expression to allow a set including an element other than “a”, “b” and “c” such as “a, b, c, and d”.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A wireless communication device comprising:
a transmitter configured to transmit a plurality of first frames by multiplexing, the plurality of first frames each belonging to any one of a plurality of groups; and
a receiver configured to receive, at timing not temporally overlapping among the groups, a plurality of second frames which are multiplexed, the plurality of second frames each indicating acknowledgement on the first frame belonging to each group.

2. The wireless communication device according to claim 1, wherein
the transmitter is configured to transmit a plurality of third frames by multiplexing to instruct receiving devices of the first frames belonging to each group to transmit the second frames.

3. The wireless communication device according to claim 2, comprising controlling circuitry configured to control to perform, in a predetermined order of the plurality of groups, multiplexing transmission of the third frames and reception of the second frames corresponding to the third frames.

4. The wireless communication device according to claim 3, wherein
the transmitter is configured to transmit, with respect to each of second and subsequent groups among the plurality of groups, a plurality of fifth frames each aggregating a different one of the third frames and a different one of a plurality of fourth frames, and
the fourth frames each contains information designating a corresponding one of the first frames to be acknowledged.

5. The wireless communication device according to claim 2, wherein
the transmitter is configured to transmit, with respect to at least one of the groups, a plurality of sixth frames by multiplexing each aggregating a corresponding one of the third frames and the first frame corresponding to the one third frame.

6. The wireless communication device according to claim 1, wherein
the transmitter is configured to transmit a third frame and the plurality of first frames by multiplexing, the third frame instructing receiving devices of the plurality of first frames to transmit the plurality of second frames, and
a receiver address of the third frame is a broadcast address or a multi-cast address.

7. The wireless communication device according to claim 1, wherein the transmitter is configured to transmit, after transmitting the plurality of first frames, a third frame instructing receiving devices of the plurality of first frames to transmit the plurality of second frames.

8. The wireless communication device according to claim 1, wherein a first multiplexing communication scheme used for the plurality of first frames is different from a second multiplexing communication scheme used for the second frames.

9. The wireless communication device according to claim 8, wherein a multiplexing number of the plurality of first frames is larger than a maximum possible multiplexing number of the second frames corresponding to each group.

10. The wireless communication device according to claim 8, wherein
the multiplexing communication scheme used for the plurality of first frames is MU-MIMO (Multi-User Multi-Input Multi-Output), OFDMA (Orthogonal Frequency Division Multiple Access), or a combined scheme of MU-MIMO and OFDMA, and
the multiplexing communication scheme used for the second frames corresponding to each group is MU-MIMO or OFDMA.

11. The wireless communication device according to claim 1, further comprising at least one antenna.

12. The wireless communication device according to claim 1, wherein the wireless communication device is an access point.

13. The wireless communication device according to claim 1 wherein communication is controlled according to an IEEE 802.11 standard.

14. A wireless communication method performed by a wireless communication terminal, comprising:
transmitting a plurality of first frames by multiplexing, the plurality of first frames each belonging to any one of a plurality of groups; and
receiving, at timing not temporally overlapping among the groups, a plurality of second frames which are multiplexed, the plurality of second frames each indicating acknowledgement on the first frame belonging to each group.

15. The wireless communication method according to claim 14, further comprising:
transmitting a plurality of third frames by multiplexing to instruct receiving devices of the first frames belonging to each group to transmit the second frames.

16. The wireless communication method according to claim 15, further comprising controlling to perform, in a predetermined order of the plurality of groups, multiplexing transmission of the third frames and reception of the second frames corresponding to the third frames.

17. The wireless communication method according to claim 16, further comprising:
transmitting, with respect to each of second and subsequent groups among the plurality of groups, a plurality of fifth frames each aggregating a different one of the third frames and a different one of a plurality of fourth frames, wherein
the fourth frames each contains information designating a corresponding one of the first frames to be acknowledged.

18. The wireless communication method according to claim 15, further comprising:
transmitting, with respect to at least one of the groups, a plurality of sixth frames by multiplexing each aggregating a corresponding one of the third frames and the first frame corresponding to the one third frame.

19. The wireless communication method according to claim 14, further comprising:
transmitting a third frame and the plurality of first frames by multiplexing, the third frame instructing receiving devices of the plurality of first frames to transmit the plurality of second frames, wherein
a receiver address of the third frame is a broadcast address or a multi-cast address.

20. The wireless communication method according to claim 14, further comprising: transmitting, after transmitting the plurality of first frames, a third frame instructing receiving devices of the plurality of first frames to transmit the plurality of second frames.
